(19) United States
(12) Patent Application Publication
(10) Pub. No.: US 2014/0132376 A1
(43) Pub. Date: May 15, 2014

(54) NANOSTRUCTURED HIGH-STRENGTH PERMANENT MAGNETS

(71) Applicant: Sungho Jin, San Diego, CA (US)

(72) Inventor: Sungho Jin, San Diego, CA (US)

(73) Assignee: The Regents of the University of California, Oakland, CA (US)

(21) Appl. No.: 14/118,206

(22) PCT Filed: May 18, 2012
(86) PCT No.: PCT/US2012/038728

§ 371 Date: Jan. 29, 2014

Related U.S. Application Data
(60) Provisional application No. 61/487,693, filed on May 18, 2011.

(51) Int. Cl. H01F 1/01; H01F 41/02

(52) U.S. Cl. CPC H01F 1/01; H01F 41/0266
USPC 335/302; 419/64; 264/109; 264/427; 75/346; 205/220; 204/192.1

(57) ABSTRACT

Materials, techniques, systems, and devices are disclosed for fabricating and implementing high-strength permanent magnets. In one aspect, a method of fabricating a magnet includes distributing particles of a first magnetic material such that the particles are substantially separated, in which the particles include a surface substantially free of oxygen. The method includes forming a coating of a second magnetic material over each of the particles, in which the coating forms an interface at the surface that facilitates magnetic exchange coupling between the first and second magnetic materials. The method includes consolidating the coated particles to produce a magnet that is magnetically stronger than each of the first and second magnetic materials.

### CROSS REFERENCE TO RELATED APPLICATIONS

This patent document claims the priority of U.S. Provisional Patent Application No. 61/487,693 entitled “NANOSTRUCTURED HIGH-STRENGTH PERMANENT MAGNETS” filed on May 18, 2011, which is incorporated by reference as part of this document.

### TECHNICAL FIELD

This patent document relates to magnetic materials and magnets.

### BACKGROUND

Various magnetic materials exhibit magnetic hysteresis which can be represented on a magnetization curve of a magnetic flux density (B) as a function of the applied magnetic field intensity (H). The size and shape of the hysteresis curve provide measurements of the magnetic properties of the material. Soft magnetic materials are magnetically soft and can be relatively easy to magnetize by applying an external magnetization field. Such soft magnetic materials can exhibit small hysteresis loops, e.g., in which the properties of soft magnetic materials can include a high initial permeability and low coercivity. Hard magnetic materials tend to maintain their initial magnetization and thus are relatively difficult to change their initial magnetization by applying an external magnetization field. Hard magnetic materials can exhibit large hysteresis loops, e.g., in which the properties of hard magnetic materials can include a high remanence, high saturation flux density, and high coercivity. In applications, hard magnetic materials with a high resistance to demagnetization can be used to construct permanent magnets. The area within a hysteresis loop can represent a magnetic energy. The magnetic hysteresis curve of a magnetic material can be used to identify important magnetic characteristics of the material including coercivity (e.g., H_{c}, which is the H value at which B is zero) and magnetic energy product (e.g., (BH)ₘₐₓ, which corresponds to the maximum area of a B-H rectangle within the second quadrant (e.g., −H values, +B values) of the hysteresis curve), which can be used as a comparative measure of the magnet strength of a permanent magnet material.

Nanotechnology provides techniques or processes for fabricating structures, devices, and systems with features at a molecular or atomic scale, e.g., structures in a range of one to hundreds of nanometers in some applications. For example, nano-scale devices can be configured to sizes similar to some large molecules, e.g., biomolecules such as enzymes. Nano-sized materials used to create a nanostructure, nanodevice, or a nanosystem that can exhibit various unique properties that are not present in the same materials scaled at larger dimensions and such unique properties can be exploited for a wide range of applications.

### SUMMARY

Materials, techniques, systems, and devices are disclosed for fabricating and implementing nanocomposite high-strength permanent magnets.

In one aspect of the disclosed technology, a method of fabricating a magnet includes distributing particles of a first magnetic material such that the particles are substantially separated, in which the particles include a surface substantially free of oxygen, forming a coating of a second magnetic material over each of the particles, in which the coating forms an interface at the surface that facilitates magnetic exchange coupling between the first and second magnetic materials, and consolidating the coated particles to produce a magnet that is magnetically stronger than each of the first and second magnetic materials.

In another aspect, a method of fabricating a particles includes dispersing bulk pieces in a dielectric fluid containing spacer particles within a container that excludes oxygen, in which the bulk pieces are of a hard magnet material, generating an electric field in the dielectric fluid using an electric pulse, in which the electric field creates a plasma in a volume existing between the bulk pieces that locally heats the bulk pieces to form structures within the volume, the dielectric fluid quenching the structures to form magnetic particles, and filtering the magnetic particles through a screen including holes of a size to allow only magnetic particles of the size or smaller to pass through the screen to a region in the container, in which the spacer particles pass through the screen and mix with the magnetic particles in the region such that the magnetic particles are substantially separated, also in which the magnetic particles include a surface substantially free of oxygen.

Implementations can optionally include one or more of the following features. For example, the method can further include collecting the magnetic particles in an environment substantially free of oxygen, forming a coating of a soft magnet material over each of the magnetic particles, in which the coating forms an interface along an outer surface of the magnetic particles that facilitates magnetic exchange coupling between the soft magnet material and the hard magnet material, and consolidating the coated magnetic particles to produce a magnet that is magnetically stronger than each of the hard magnet and soft magnet materials.

In another aspect, a method of fabricating a particles includes dispersing bulk pieces in a dielectric fluid within a container that excludes oxygen, in which the bulk pieces are of a composite material including regions of a hard magnet material and regions of a soft magnet material, generating an electric field in the dielectric fluid using an electric pulse, in which the electric field creates a plasma in a volume existing between the bulk pieces that locally heats the composite material to form hard magnet structures and soft magnet structures within the volume, the dielectric fluid quenching the hard magnet structures and the soft magnet structures to form hard magnetic particles and soft magnetic particles, and filtering the hard magnetic particles and the soft magnetic particles through a screen including holes of a size to allow only hard magnetic particles and soft magnetic particles of the size or smaller to pass through the screen to a location in the container, in which the hard magnetic particles and the soft magnetic particles each include a surface substantially free of oxygen.

In another aspect, a magnet includes nanoparticles comprised of a first magnetic material having a first magnetic energy product, in which the nanoparticles include a surface substantially free of oxygen, a layer covering each of the nanoparticles and forming an interface at the surface, in which the layer is comprised of a second magnetic material having a second magnetic energy product, and a metallic casing containing the layer-covered nanoparticles, in which the interface facilitates magnetic exchange coupling between the first and second magnetic materials.

In another aspect, a magnet includes nanoparticles comprised of a first magnetic material having a first magnetic energy product, in which the nanoparticles include a surface substantially free of oxygen, a layer covering each of the nanoparticles and forming an interface at the surface, in which the layer are comprised of a second magnetic material having a second magnetic energy product, and a nonmagnetic matrix material encasing the layer-covered nanoparticles, in which the interface facilitates magnetic exchange coupling between the first and second magnetic materials.

In another aspect, a magnetic device includes a soft magnet material exhibiting high saturation magnetization and forming a soft magnetic matrix, and a hard magnet material configured in one or more nanometer regions embedded in the soft magnetic matrix to form an exchange-coupled magnet structure, in which the exchange-coupled magnet structure includes a magnetic energy product greater than that of the hard magnet material and the soft magnet material.

The subject matter described in this patent document can be implemented in specific ways that provide one or more of the following features. For example, the disclosed technology includes structures and methods to produce such engineered magnetic structures having various configurations of hard magnet and soft magnet nanoscale regions that enhance the exchange coupling between these regions, e.g., leading to greater magnetic strength (e.g., which can be represented by the magnetic energy product) of the engineered magnet as compared to each of the hard magnet and soft magnet material on their own. For example, implementations of the disclosed fabrication techniques can produce permanent magnets of the disclosed technology in bulk at lower cost and reduced risk, e.g., in comparison to existing permanent magnets that can depend on scarce and globally critical rare earth minerals. The disclosed nanostructured high-strength permanent magnets can be used in a variety of applications including the growing hybrid/electric vehicle and wind turbine generator industries.

### BRIEF DESCRIPTION OF THE DRAWINGS

FIGS. 1A-1F show exemplary illustrative schematic configurations of the disclosed nanocomposite magnets.

FIG. 2 shows a schematic illustration of an exemplary spark erosion cell.

FIG. 3 shows an image of exemplary sub-50 nm diameter alloy nanoparticles produced by exemplary spark erosion techniques.

FIG. 4 shows an image of an of an exemplary ultrafine grained MnBi starting material used in exemplary spark erosion techniques.

FIG. 5 shows a data plot of an M-H magnetization loop for exemplary spark eroded MnBi nanoparticles.

FIG. 6 shows a schematic illustration of an exemplary electroplating bath configuration to implement an electrodeposition process of the disclosed technology.

FIG. 7 shows a schematic illustration of a cross-sectional view of an exemplary electroplating system.

FIG. 8 shows a schematic illustration of an exemplary fluidized bed apparatus for coating magnet nanoparticles with a coating.

FIG. 9 shows a schematic illustration of an exemplary fluidized bed apparatus with a particle-dispersing mechanism for coating magnet nanoparticles with soft magnet coating.

FIG. 10 shows a schematic illustration of an exemplary far-away-sputtering technique for coating nanoparticles.

FIG. 11 shows a schematic illustration of an exemplary technique for coating elongated nanoparticles.

FIG. 12 shows a schematic illustration of a process to insert, press and sinter core-shell nanoparticles.

FIGS. 13A and 13B shows a schematic illustration of an exemplary elongated and aligned exchange-coupled spring magnet alloy in bulk form.

FIG. 14 shows schematic illustrations of exemplary core/shell magnet compaction by plastic deformation.

FIGS. 15A and 15B show schematic illustrations of exemplary hard magnet nanoparticle surface coatings of smaller diameter soft magnet nanoparticles.

FIG. 16 shows a schematic illustration of an exemplary spark erosion apparatus to produce nanocomposite structures during sparking.

FIG. 17 shows schematic illustrations of exemplary spark erosion techniques to produce various configurations of soft magnet coatings or second phase material coatings.

FIG. 18 shows schematic illustrations of consolidation of exemplary spark eroded core/shell nanostructures to form exemplary elongated and aligned exchange-coupled magnets.

FIG. 19 shows a schematic illustration of an exemplary spark erosion apparatus including hard magnet and soft magnet composite electrodes.

FIG. 20 shows schematic illustrations of consolidation of exemplary spark eroded hard magnet and soft magnet mixed nanoparticles to form exemplary elongated/flaked and aligned exchange-coupled magnets.

FIG. 21 shows an exemplary diagram of a triple layered particle structure.

FIG. 22 shows an exemplary diagram demonstrating deformation compaction or elongation of jacketed preform material containing triple layered metal nanocomposite particles.

FIG. 23 shows a schematic illustration of an exemplary spark erosion apparatus including rare earth containing composite electrodes.

FIG. 24 shows a schematic demonstrating the mixing and consolidation of exemplary separately-spark eroded hard magnet and soft magnet nanoparticles.

FIG. 25 shows a schematic of exemplary two phase mixed nanoparticle phase structures.

FIG. 26 shows a schematic of exemplary nanoparticles from composite materials of exemplary hard magnet phase and grain boundary barrier phase structures.

Like reference symbols and designations in the various drawings indicate like elements.

### DETAILED DESCRIPTION

Rare earth elements, such as lanthanide elements and other rare earth elements, tend to possess unique magnetic, optical, and chemical properties that are useful in a variety of products and applications, e.g., including permanent magnets for motors, generators and batteries in automotive and clean energy applications. Global competition for these materials and their limited availability (e.g., some from a single source) can present a risk to clean energy technology development. For these reasons, among others, it is important to develop alternatives that reduce or eliminate dependency on rare earth materials.

Described herein are engineered nanostructures and methods of their fabrication that demonstrate exemplary means for improving permanent magnet properties (e.g., such as increased coercive force and magnetic energy product) of magnetic materials by engineering the structure of the material at nanoscale dimensions.

The disclosed technology includes techniques of producing and implementing engineered magnetic materials having magnetically hard and soft phases that interact by magnetic exchange coupling to enhance the permanent magnetic effect of the engineered material. For example, the described permanent magnet materials can be configured to have low or zero rare earth element content. These exemplary permanent magnet materials can be configured to have a large permanent magnetic energy product, e.g., which can be due to the combination of a large permanent magnet field and magnetization. The disclosed technology includes techniques to control the structure, dimensions, orientations, and other factors of the hard and soft magnetic phases within the engineered magnetic material that maximize the efficiency of magnetic exchange coupling, and thereby increase the magnetic strength as represented by the permanent magnetic energy product and/or the magnetic coercivity of the engineered magnetic material. For example, the magnetic energy product of an exemplary engineered magnetic material is greater than that of the magnetic energy product of each of the hard and soft magnetic materials. For example, the magnetic coercivity of an exemplary engineered magnetic material is greater than that of the magnetic coercivity of each of the hard and soft magnetic materials. The disclosed technology employs techniques to limit the oxidation at the interface between the hard and soft magnetic materials during fabrication of the engineered magnetic materials, e.g., which can thereby produce the engineered magnetic materials essentially oxygen free, and thereby maximize the efficiency of magnetic exchange coupling of the engineered magnetic material. Additionally, the disclosed technology includes techniques to disperse and maintain the separation of the materials during fabrication of the engineered magnetic materials, e.g., which can provide greater available surface area between the hard and soft magnetic materials to join, and thereby maximize the efficiency of magnetic exchange coupling of the engineered magnetic material.

The disclosed engineered magnetic materials can be produced by using two-phase nanocomposites of hard and soft phases, in which the interface area for exchange coupling is substantially increased, and where the magnetic anisotropy is aligned. For example, exchange interactions at the hard magnet—soft magnet interface can result in the overall magnetic saturation value of the exemplary engineered material being substantially higher than that of a magnetic material of a permanent magnet alloy phase alone (e.g., such as an exclusive MnBi system). For example, the permanent magnetic energy product of an exemplary engineered magnetic material of the disclosed technology can be enhanced by increasing magnetization due to the exchange-coupled soft magnet with higher saturation moment.

Materials, techniques, systems, and devices are disclosed for fabricating and implementing nanocomposite high-strength permanent magnets. For example, exemplary techniques are described to produce the disclosed engineered permanent magnet materials in bulk form, e.g., which can include producing the exemplary permanent magnets at lower cost and reduced risk in comparison to existing permanent magnets (e.g., of which many depend on scarce rare earth minerals). For example, the disclosed engineered magnetic materials can also be referred to as exchange spring magnets, or alternatively, exchange-coupled magnets.

In one aspect, the disclosed technology includes fabrication techniques to produce high-strength permanent magnet nanocomposites formed of hard magnet and soft magnet nanostructures to produce exchange-coupled spring magnets.

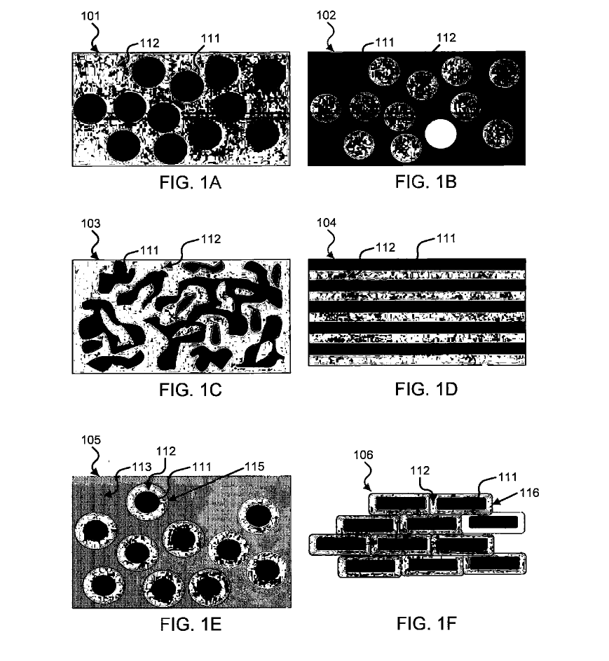

Various configurations of the disclosed magnetic nanocomposites suitable for permanent magnets with enhanced exchange coupling are illustrated and described in the exemplary schematics of FIGS. 1A-1F. In some examples, nanometer-scale regions of a hard magnet material can be configured as isolated islands embedded in a soft magnet matrix; or vice versa, in which the soft magnet material can be configured as isolated islands embedded in a hard magnet matrix; or, the hard and soft magnet materials can be intermingled together; or, the hard and soft magnet materials can be formed in an alternating multilayered structure; or, the hard and soft magnet materials can be structured as a core/shell structure having a hard magnet core and soft magnet shell; or vice versa, in which the core/shell configuration includes a soft magnet core and hard magnet shell.

FIG. 1A shows a schematic of a magnetic material 101 that includes a hard magnet material 111 configured in nano-scale regions that are embedded in a matrix material of a soft magnet material 112, e.g., with intimate interfacial bonding. For example, the hard magnet material 111 can include high-coercivity magnetic materials, e.g., including, but not limited to, MnBi, MnAl, MnAlC, or their alloys with other elements, Ba-hexaferrites, Sr-hexaferrites, rare earth magnets (e.g., rare earth cobalt or NdFeB type magnets, or modified NdFeB magnets including alloying elements), Sm—Co based magnets, nitride based permanent magnets (e.g., Fe-nitride magnets), L1₀ type magnets including Fe—Ni, FePt, CoPt, CoPd magnets, carbide based permanent magnets (e.g., cobalt carbide magnets (e.g., Co₂C or Co₃C)), or magnet materials with alloying additions of Co and other elements, or other high coercivity permanent magnet materials. For example, the soft magnet material 112 can include high saturation magnetization materials, e.g., in which the saturation magnetization includes at least 30% higher than that of the hard magnet material. For example, the soft magnet material 112 can include, but is not limited to, Fe, Fe alloyed with 30-60 weight % Co, or other Fe-alloys (e.g., including Si steel, Ni—Fe permalloys, Fe—Co—V, amorphous metglas alloys, or higher saturation soft ferrites). For example, an exemplary 65% Fe-35% Co alloy can exhibit a saturation magnetization (4πMs) value as high as ˜24 KG (kilo Gauss), e.g., as compared to MnBi base magnet system having a 4πMs value of ˜7.9 KG.

For example, the hard magnet nano-scale regions 111 can be configured to a size on the order of the domain wall thickness. A domain wall is an interface separating magnetic domains. For example, the domain wall can represent a transition between different magnetic moments, e.g., exhibiting an angular displacement of 90° or 180°, and a gradual reorientation of individual magnetic moments across a finite distance. The domain wall thickness size can be determined based on the anisotropy of the hard magnet material 111.

FIG. 1B shows a schematic of a magnetic material 102 that includes the soft magnet material 112 configured in nano-scale regions that are embedded in a matrix material of the hard magnet material 111.

FIG. 1C shows a schematic of a magnetic material 103 that includes the hard magnet material 111 and the soft magnet material 112 intermingled together. For example, the hard magnet material 111 and the soft magnet material 112 are configured in nano-scale regions, which can be sized to the level of domain wall thickness. The exemplary magnetic material 103 can be configured as a random two-phase or multi-phase structure.

FIG. 1D shows a schematic of a magnetic material 104 that includes a multilayer structure of alternating hard magnet and soft magnet materials. For example, the material 104 can include a layer of the hard magnet material 111 formed over a layer of the soft magnet material 112, which can be are configured in multiple, alternating layers of the hard magnet material 111 and soft magnet material 112. In some example, the layers can be configured to have the same thickness. In other examples, the layers can be configured to have different thickness (e.g., the layer of the soft magnet material 112 having a larger thickness than the layer of the hard magnet material 111). For example, the layers can be sized to the domain wall thickness.

In some implementations, the exemplary multilayered magnetic material 104 can be fabricated by using thin film deposition or thick film processing techniques. For example, an exemplary thick film processing technique can include spin-coating, spray coating, plasma spraying, or another related processing technique followed by a baking/annealing process to remove binders, solvents or other additives mixed with the precursor material layers. Exemplary precursor materials for hard magnet layers can include oxygen-free materials such as MnBi chloride, MnBi fluoride, or salts of hard magnet material mixed with polymer binders and solvents. Exemplary precursor materials for soft magnet layers can include oxygen-free materials such as (Fe—Co) chloride, or a salt or polymer complex containing Fe, Co, Ni or other magnetic metals. In some examples, the baking/annealing process can be an optional process. The exemplary precursor materials can be decomposed later into an alloy phase, e.g., by using heat treatment in an invert, vacuum, or reducing atmosphere (e.g., such as hydrogen-containing or ammonia-containing environment).

FIG. 1E shows a schematic of a magnetic material 105 having a core/shell structure 115 that includes a core nanoparticle of the hard magnet material 111 embedded in a shell of the soft magnet material 112, and the core/shell structure 115 embedded in a non-magnetic matrix material 113. For example, the non-magnetic matrix material 113 can include materials, e.g., including, but not limited to, epoxy, polymer resin, copper, aluminum, or ceramic materials (e.g., such as alumina), among others. For example, the exemplary core/shell structure 115 can be configured as coated nanoparticles, e.g., in which the core can be configured in a variety of shapes, including, but not limited to, a sphere, cone, rod, rectangular solid, tube, among others. For example, the core/shell structure 115 can be prepared with the core and shell dimensions (thickness) in the range of substantially ˜1-2 times magnetic domain wall thickness. For example, the core and shell dimensions can be in the range of substantially 10-40 nm for materials using rare earth magnets (e.g., rare earth cobalt or NdFeB magnets), or for example, slightly larger thicknesses for materials using for MnBi or MnAl type magnets. For example, the core size can be configured to range from 10-300 nm, and in some examples in a range of 30-100 nm. For example, the soft magnetic shell thickness can be configured to range from 5-80 nm, and in some examples in a range of 10-50 nm.

In some examples, the exchange coupling of the disclosed nanocomposite magnets can occur via exemplary core-shell configurations (e.g., the core/shell structure 115 of FIG. 1E and elongated or compacted core/shell structure 116 of FIG. 1F). The atomic contact between the hard magnet nanoparticles coated by the soft magnet material can facilitate exchange interactions. In some examples, the hard magnet nanoparticles are in contact, e.g., via exchange-coupling, with the soft magnet material at a maximum interface area. For example, the maximum interface area can be controlled by controlling the size of the permanent magnet material (e.g., reducing the size of the permanent magnet material can increase the size of the interface area). In some examples, small nanoparticles with dimensions below certain limits may be difficult to control and may approach the superparamagnetic range, e.g., if the particle size is below just a few several nanometers (e.g., 5-10 nm in diameter). In some examples, the size of an exemplary core-shell structure can include the core hard magnet material on the order of substantially ˜10-100 nm and the soft magnet material coating on the order of substantially ˜10-50 nm, e.g., rendering the overall size of the exemplary core-shell structure on the order of substantially ˜20-150 nm.

FIG. 1F shows a schematic of a magnetic material 106 having a flattened and aligned core/shell structure 116 that includes a core nanoparticle of the hard magnet material 111 embedded in a shell of the soft magnet material 112. For example, the core/shell structure 116 of the material 106 can be flattened (e.g., similar to a pancake or ribbon shape) to have a substantially compacted and aligned geometry that can be formed after substantial removal of empty space and porosity for higher energy product magnets. For example, the core/shell structure 116 can be produced from the core/shell structure 115, e.g., as assembled into an aggregate of spherical particles shown in FIG. 1E, which can contain substantial porosity between adjacent spheres, which can reduce the total energy product. In this example of the compacted core-shell structure (e.g., core/shell structure 116), no nonmagnetic binder or matrix material (e.g., such as epoxy, Cu or Al) is employed so as to achieve higher energy products per unit volume of the nanocomposite magnet material.

In some examples, the magnetic material 106 can include a structure that is a crystallographically aligned (e.g., textured by at least 50%, and in some examples, by at least 70%) along the easy axis of magnetization (energetically favorable direction of spontaneous magnetization). For example, the magnetic material 106 can include a mechanically and/or magnetically aligned configuration along the easy axis of magnetization. For example, in the case of an exemplary MnBi based binary, ternary or multicomponent alloy system, an alignment along the c-axis of the hexagonal MnBi phase or perpendicular to the c-axis can be configured, e.g., which can be based on how the compacted magnets are sliced/shaped and used for particular applications. For example, such crystallographic (and magnetic) alignments can be accomplished for the exemplary exchange spring magnet by magnetic field alignment of the core-shell nanoparticles prior to the compaction, e.g., by pressing or uniaxial mechanical deformation (e.g., though cold rolling, warm rolling, swaging, extrusion, rod rolling or wire drawing).

For example, the disclosed technology can include the use of MnBi alloy materials as the exemplary hard magnet material 111 used in the various configurations of the exchange spring magnet. MnBi alloys can include a high magnetic anisotropy and high energy product, as well as have a relatively inexpensive materials cost (e.g., as compared to rare earth elements). For example, MnBi systems can include two primary magnetic phases, e.g., a paramagnetic, high temperature MnBi intermetallic phase (beta-MnBi phase) and a more strongly magnetic, low temperature MnBi phase (alpha-MnBi phase, with a Curie temperature of ˜628 K).

Additionally, MnBi systems can also include a metastable, quenched high temperature phase (e.g., which is ferromagnetic, but with a lower Curie temperature of ˜460 K).

For example, the low temperature phase (LTP) of an exemplary MnBi intermetallic compound (e.g., having a NiAs-type hexagonal crystal structure and higher Curie temperature) is a rare earth-free magnetic material that includes a large magnetocrystalline anisotropy field and a positive temperature dependence of magnetocrystalline anisotropy and coercive force up to ˜200° C., e.g., which is close to the operating temperature of automobile motors using permanent magnets. This can imply a mitigated temperature dependent loss of magnet strength found in most of the other permanent magnets including the rare earth-containing magnets. While an LTP phase MnBi material can possess potential to be a strong and low-cost permanent magnet, it is very difficult to prepare the desired single phase compound using conventional alloy preparation methods, e.g., such as induction melting, arc-melting, mechanical mixing and sintering, which may be primarily due to the peritectic phase diagram and the tendency of Mn and Bi phases to segregate from the Mn—Bi liquid during cooling.

Fabrication techniques are disclosed for producing nanocomposite magnets having the exemplary core-shell configurations and the embedded/intermingled configurations. For example, the disclosed technology includes the following fabrication and processing techniques to produce magnet nanoparticles (e.g., providing the permanent magnet of the exemplary nanocomposite material) and a coating layer (e.g., a metallic coating) on the nanoparticle surface. For example, methods of fabricating the exemplary magnet nanoparticles can include mechanical pulverization, chemical precipitation, atomization, and spark erosion, among other techniques. The exemplary coating processes can include at least one of (i) electrolytic or electroless deposition, (ii) fluidized bed deposition of floating nanoparticles of hard magnet with soft magnet coating, (iii) metal jacket uniaxial plastic deformation for co-deformation and consolidation of hard magnet powder and soft magnet powder in nano dimensions, and (iv) chemical decoration of the hard magnet particle surface (e.g., MnBi or MnAlC particles, among others) with soft magnet ions and/or nanoparticles through surface modifications with functionalization and/or self-assembly of coated nanoparticles.

In some examples to fabricate the exemplary exchange-coupled, high strength permanent magnets of the disclosed technology, the nanoparticles are first synthesized.

For example, spark-erosion is one of the exemplary methods for fabricating nano- or micro-sized structures from many types of metals and alloys, e.g., producing the hard, soft, or hybrid hard-soft magnet materials while inhibiting or preventing oxidation of the produced hard, soft, or hybrid hard-soft magnet materials. These exemplary spark-erosion produced metal and alloy nanostructures can have average sizes ranging from a few nanometers to tens of micrometers. An exemplary spark erosion technique to produce spark-eroded metal and alloy nanostructures of the disclosed technology can include a spark erosion cell having two electrodes and charge pieces comprised of the material of interest (e.g., the hard, soft, and hybrid hard-soft magnet materials) disposed on a perforated screen and immersed in a dielectric liquid.

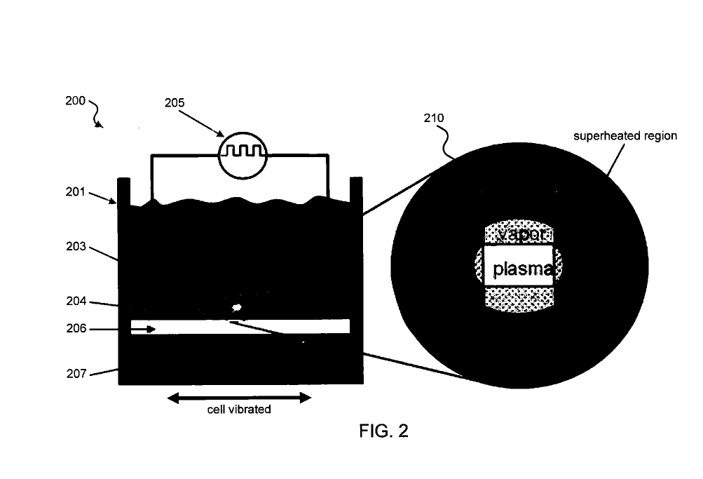

FIG. 2 shows a schematic illustration of a spark erosion cell 200 for fabricating permanent magnet nanoparticles, e.g., of alloy, nitride, carbide, or other materials. The exemplary spark erosion cell 200 can include a container 201 that contains a dielectric fluid 202, e.g., such as liquid nitrogen or liquid argon. For example, the dielectric fluid 202 can be a fluid that is free of oxygen, and the utilization of the dielectric fluid 202 in the disclosed spark erosion processes can inhibit oxidation of the produced nanoparticles (e.g., producing magnetic nanoparticles that are substantially free of oxygen). The exemplary spark erosion cell 200 can include electrodes 204 in connection to a pulsed power source 205. For example, an exemplary spark erosion process can include vibrating the exemplary spark erosion cell 200, e.g., by using a shaker-pot configuration or rotating-electrodes configuration. Charge pieces 203 can be introduced into the dielectric fluid 202 of the exemplary vibrating spark erosion cell 200. For example, the charge pieces 203 can include bulk material pieces of the hard magnet material 111, and in some examples, bulk material pieces of the soft magnet material 112. In some examples, the charge pieces 203 introduced in the dielectric fluid can be of a millimeter to centimeter size regime. For example, the electrodes 204 and the charge pieces 203 can be made to come closer frequently by intentionally-generated mechanical vibrations, e.g., with the two rotating target materials (e.g., charge pieces 203) coming in near-contact frequently during their rotation in proximity. Electric fields can be generated in the gaps existing between the electrodes 204 and the charge pieces 203 adjacent to the electrodes 204, and between neighboring charge pieces 203. For example, microplasmas (sparks) can be generated in these exemplary gaps, e.g., when the electric field in a gap is greater than the breakdown field of the dielectric. The exemplary generated microplasmas exhibit high temperatures that provide localized heat to the charge pieces 203. For example, since the spark temperatures are very high (e.g., ˜10,000 K), localized regions across the exemplary gaps are superheated by absorbing energy from the sparks (e.g., as shown in inset 210). For example, when the spark collapses, tiny particles (e.g., molten droplets and/or vaporized material which can be of a nanometer size) can be ejected into the dielectric, e.g., in which the tiny structures are rapidly quenched/condensed to form solid spark eroded particles 207. For example, in situ quenching of the exemplary droplets or condensed vapor can produce amorphous or nanocrystalline material, e.g., including spherical particles. For example, since oxygen can be substantially kept out of the spark erosion apparatus 200, the spark eroded particles 207 are produced in a manner that is considerably oxidation-free and include a substantially non-oxidized outer surface. These exemplary spark eroded particles 207 particles can pass through a perforated mounting screen 206 located at an end (e.g., the bottom) of the exemplary spark erosion cell 200. The spark eroded particles 207 can be subsequently collected and processed. For example, the container 201 containing the spark eroded particles 207 can be brought into an enclosed glove box or other enclosure having an inert atmosphere, and the dielectric fluid 202 (e.g., liquid nitrogen or liquid argon) can be permitted to evaporate. The nanoparticles can then further processed, if desired for example, for separation of the spark eroded particles 207 into different size groups, e.g., by sieving, gravitational separation or centrifugal separation. These processing steps can be conducted in an inert atmosphere to inhibit surface oxidation of the nanoparticles.

An exemplary spark erosion process to produce nano- or micro-sized structures of hard, soft, or hybrid hard-soft magnet materials can include: dispersing bulk charge pieces 203 of the magnetic material into the dielectric fluid 202 within the container 201; generating an electric field in the dielectric fluid 202 using an electric pulse, in which the electric field creates a plasma in a volume (e.g., on a micro-volume scale) that exists between bulk charge pieces 203 and locally heats the bulk pieces to form structures (e.g., molten droplets or local vapor regions) within the volume, which can be subsequently ejected into the dielectric fluid 202 and quenched to form the spark eroded magnetic particles 207; and filtering the spark eroded magnetic particles 207 through a screen 206 (e.g., that includes holes of a desired size to allow only magnetic particles of the desired size or smaller to pass through) to a region within the container 201, in which the dielectric fluid 202 inhibits oxidation (e.g., to substantially be free of oxygen) of the surface of the spark eroded magnetic particles 207.

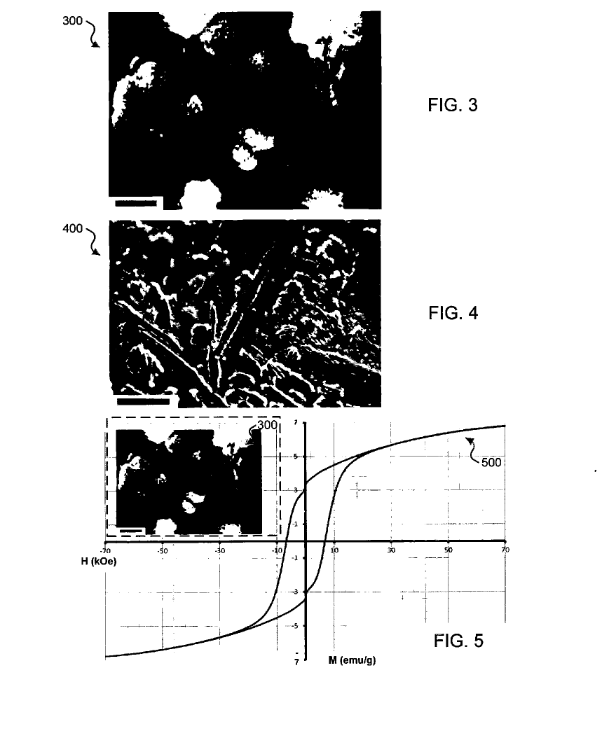

Implementation of the exemplary spark erosion process can produce nanoparticles to be used in the disclosed nanocomposite exchange-coupled magnets. FIG. 3 shows a scanning electron microscopy (SEM) image 300 of an exemplary spark-eroded MnBi alloy nanopowder, which is on the order of ˜40 nm average diameter. The image 300 includes an exemplary scale bar representing 50 nm. For example, the dimension range demonstrated by the exemplary spark-eroded MnBi alloy nanopowder is suitable for the exchange-coupled, high energy product permanent magnets of the disclosed technology. Various sizes of nano- and micro-scale particles can be obtained by manipulating the spark erosion power, pulse current duration, and/or overall time of the described spark erosion process.

The exemplary spark erosion techniques can be implemented to produce metallic nanoparticles or conducting nanoscale compounds (e.g., such as metal-nitrides, metal-carbides, etc.) with minimal surface oxidation. For example, the interface between an exemplary hard magnet particle and exemplary soft magnet coating can be achieved by implementing the disclosed techniques (e.g., the disclosed spark erosion techniques) to successfully produce the described exchange spring magnets without introducing oxidation to the interface. For example, minimal surface oxidation of the exemplary spark eroded particles can be due to extremely rapid condensation and quenching of the spark eroded particles to room temperature or below in the dielectric liquid, e.g., thus minimizing the time for oxidation and eliminating exposure to anything other than the dielectric liquid. Exemplary spark erosion processes can be carried out in dielectric media of cryogenic liquids, e.g., such as liquid nitrogen (e.g., at −196° C.) or liquid argon (e.g., at −189° C.), which results in very little driving force for surface oxidation. Thus, exemplary spark eroded magnet alloy nanoparticles of the disclosed technology can be configured to contain surface oxidation of less than 3.0 weight % (wt %) of the total alloy contents, and in some examples less than 1.5 wt % or even less than 0.5 wt %.

The use of spark erosion synthesized magnet nanoparticles can include advantages over other types of nanoparticle preparation techniques. For example, mechanical grinding processes of alloy ingot, or even grinding processes of atomized particles (e.g., typically tens of micrometers in diameter), as well as other mechanical ball milling processes from ingots, can require many hours of processing to obtain micrometer and/or nanometer size particles, in which oxidation of the metal nanoparticle surface cannot be avoided. Additionally, chemical synthesis techniques of metal or alloy nanoparticles in aqueous solutions can often lead to surface oxidation, unless the chemical environment, pH and other reaction parameters are very carefully controlled. For example, in a typical ball milling machine, the steel balls (or zirconia balls or other ceramic balls) can wear out together with the magnet alloy materials, e.g., resulting in the ball diameter being substantially reduced after hours of attrition milling. Alloy contaminations can occur as the worn-out alloy steel ball material (or zirconia or other ceramic ball material) gets mixed up with the ground alloy powder. For example, during many hours of milling processing the nanoparticles in aqueous environment (including local heating during impact grinding), surface oxidation can easily occur. In contrast, for example, the disclosed spark erosion synthesis techniques can be implemented to produce magnetic nanoparticles with essentially non-oxidized surfaces in a manner that is also crucible-free, direct, and rapid for oxidation-free and contamination-free nanoparticles processing.

The disclosed technology can include methods, systems, and devices for controlling grain size of spark erosion electrodes and charge materials, which can be used to obtain near stoichiometric low temp phase (alpha MnBi).

For example, a spark erosion process of the disclosed technology includes single phase MnBi as a material for the electrodes and bulk charge pieces of the exemplary spark erosion cell 200 (shown in FIG. 2). However, a single phase MnBi compound that exhibits a strong magnetic moment can be difficult to obtain, e.g., due in part to the peritectic phase relationship in the alloy system. To achieve a single phase MnBi material for use in the disclosed spark erosion process, the starting MnBi material can be configured to have a very small average grain size. For example, the sparking size in the spark erosion activity zone can include a size in a range between 50-100 μm. Therefore, for example, if the grain size of multiphase material is less than 100 μm, a single phase LTP phase MnBi can be obtained. For example, the single phase LTP phase MnBi can be obtained even if the electrode structure contains a multiphase structure but the average composition within the 50-100 μm volume containing several grains is close to MnBi stoichiometry. However, for example, if the average grain size is larger than 100 μm, then segregated Bi grains or Mn grains of this size (or larger) can be present, from which the spark erosion process could produce nanoparticles of Bi or Mn rather than the MnBi nanoparticles. For example, according to the disclosed technology, the average grain size for fabrication of exemplary MnBi nanoparticles (e.g., to be used for the disclosed high-energy exchange spring magnets) can be configured to sizes less than 100 μm, e.g., and in some examples, the grain sizes can be less than 70 μm, and even less than 30 μm.

In addition to the exemplary MnBi system, the starting materials having an ultrafine grain size implemented in the exemplary spark erosion process can include using other magnet materials, e.g., such as MnAl, MnAlC, NdFeB, L1₀ phase magnets (e.g., including FePt, CoPt, NiFe, FePd), some nitride magnetic materials (e.g., including Fe₁₆N₂ or Fe₃N magnetic nitride), or some carbide based magnetic materials (e.g., including CoₙC (n=1-6, such as Co₂C and Co₃C)), among others. These exemplary starting materials can also be used to produce the compositionally more stoichiometric alloy nanoparticles in a high yield. Additionally, for example, the MnBi, MnAl and other hard magnet systems used for the exemplary core nanoparticles can also be alloyed by Co, Fe, Al, Cu, Ag, Zn, Si, Sn, Sb, Bi, Mg, as well as other transition metals and their alloys, e.g., by at most 20 wt %, or in some examples, at most by 10 wt %.

Nanoparticles (or microparticles) of Mn, Bi, or MnBi can be well mixed and rapidly sintered to form the exemplary ultrafine grained spark erosion electrodes and charge pieces. For example, an ultrafine grained MnBi starting material was fabricated by rapid solidification using a metallic mold to rapidly solidify the molten MnBi alloy from above the liquidus temperature, as shown in FIG. 4. FIG. 4 shows an image 400 of an of an exemplary ultrafine grained MnBi starting material used for improved spark erosion into compositionally more uniform and less segregated MnBi phase nanoparticles. The image 400 includes an exemplary scale bar representing 100 μm. The optical microscope image 400 shows that the average grain size (or the shortest dimension in the case of elongated grains) in this exemplary chill cast MnBi ingot (e.g., molten alloy poured into a metallic mold for faster solidification) is ˜30 μm. The exemplary ˜30 μm grain size fits within the desired size regime of the disclosed technology, e.g., well below the upper limit of the typical size of an exemplary sparking volume (e.g., 50-100 μm). For example, an average solidification cooling rate of the exemplary techniques to obtain the desired small grain size (e.g., solidification from 1200° C. to 200° C.) can include at least 50° C./min, and in some examples at least 100° C./min, and some other examples, at least 200° C./min. For example, for the MnBi target material in the image 400, spark erosion was carried out at 200 V and a capacitance of 122 μf, with the exemplary spark erosion charge cell shaken/vibrated at a frequency of ˜10 Hz. The dielectric media used in the exemplary spark erosion charge cell was liquid nitrogen. For example, the use of the liquid nitrogen as the dielectric media resulted in minimized oxidation of nanoparticles (e.g., substantially zero oxidation of the MnBi nanoparticles).

Such an ultrafine grained MnBi starting material used for improved spark erosion can produce compositionally more uniform and less segregated MnBi phase nanoparticles (e.g., mostly MnBi phase with substantially zero or reduced amount of Bi and Mn phases). The spark eroded MnBi particles exhibit high saturation magnetization and high coercive force, as shown in FIG. 5, e.g., which can be due to the predominantly strong magnetic MnBi low temperature phase. FIG. 5 shows an M-H magnetization loop 500 for exemplary spark eroded MnBi nanoparticles. The exemplary spark eroded MnBi nanoparticles used to produce the M-H magnetization loop 500 included the nanoparticles shown in the image 300 of FIG. 3, which were produced using an exemplary spark erosion process utilizing the ultrafine grained MnBi spark erosion target material shown in the image 400 of FIG. 4.

For example, the M-H magnetization loop 500 for the exemplary spark eroded nanoparticles of MnBi shows a high coercive force of as high as ˜7 KOe and high magnetic saturation value more than 95% of the known 4πMₛ value of ˜7.9 KG for the LTP phase MnBi compound. This high coercive force and high magnetic saturation value demonstrated by the exemplary M-H magnetization loop 500 can be achieved, for example, particularly after annealing within the low temperature phase stability region below 300° C. (e.g., at 200-300° C. for 2-24 hr for diffusional homogenization). By implementing such annealing techniques, the volume fraction of the low temperature phase can be improved with desirably higher magnetic saturation and can allow the saturation magnetization of the MnBi powders to reach at least 80% (and in some examples, at least 90% of the theoretical bulk magnetization of the MnBi low temperature phase). For example, because of the disclosed advantageous properties of MnBi phase (e.g., exhibiting increased magnetic anisotropy and increased coercive force), the exemplary spark eroded MnBi nanoparticles annealed at 300° C. showed a high coercive force of more than 12 KOe at a temperature of 113° C. For example, at even higher operating temperatures (e.g., including ˜200° C. near the operating temperature of electric motors for automobiles), even further enhanced, higher coercive force can be achieved.

Magnetic exchange coupling can be implemented through the core-shell configuration (e.g., exemplified in FIG. 1E and FIG. 1F). For example, to synthesize the exemplary core-shell configurations, the surface of the hard magnet material nanoparticles can be coated with a soft magnet material coating. The disclosed technology includes the following exemplary processing techniques to enable such metallic coating on the nanoparticle surface. These exemplary coating processes can include (i) electrolytic or electroless deposition, (ii) fluidized bed deposition of floating nanoparticles of hard magnet with soft magnet coating, (iii) metal jacket uniaxial plastic deformation for co-deformation and consolidation of hard magnet powder and soft magnet powder in nano dimensions, and (iv) chemical decoration of the hard magnet particle surface with soft magnet ions or nanoparticles (e.g., through surface modifications with functionalization and/or (optional) self assembly of coated nanoparticles), followed by mechanical deformation (e.g., by pressing, rolling, swaging, extrusion, rod drawing, or other elongation deformation techniques) that can locally flatten and enhance atomic contact of the hard magnet base and the soft magnet coating. In some examples of the chemical decoration and subsequent mechanical deformation techniques, the coating with soft magnet is not necessarily continuous.

The disclosed technology can include methods, systems, and devices for surface coating of magnet nanoparticles for core/shell structured exchange spring magnets, e.g., by electrochemical or chemical means.

For example, subsequent to the fabrication of the magnet nanoparticles (e.g., providing the permanent magnet of the exemplary nanocomposite material), these exemplary nanoparticles can be coated with a soft magnet material to form a shell (e.g., surface coverage) in atomic contact for exchange interactions. The atomic contact between the permanent magnet nanoparticles and soft magnet coating are in contact via exchange-coupling, e.g., which can be configured to maximize the interface area by minimizing the size of the exemplary nanoparticles. For example, the exemplary permanent magnet nanoparticles can include MnBi, MnAl, MnAlC, or their alloys with other elements, Ba- or Sr-hexaferrites, rare earth magnets (e.g., rare earth cobalt or NdFeB type magnets, or modified NdFeB magnets including alloying elements), Sm—Co based magnets, nitride based permanent magnets (e.g., Fe-nitride magnets), L1₀ type magnets including Fe—Ni, FePt, CoPt, CoPd magnets, carbide based permanent magnets (e.g., cobalt carbide magnets (e.g., Co₂C or Co₃C)), or magnet materials with alloying additions of Co and other elements, or other high coercivity permanent magnet materials. The soft magnet material to be coated on the hard magnet surface can include, but is not limited to, Fe, Fe alloyed with 30-60 weight % Co, or other Fe-alloys, Ni—Fe permalloys. For example, an exemplary 65% Fe-35% Co alloy can exhibit a saturation magnetization (4πMs) value as high as ˜24 KG (kilo Gauss), e.g., as compared to MnBi base magnet system having a 4πMs value of ˜7.9 KG.

Exemplary electrolytic deposition techniques to fabricate the core/shell structure for the disclosed exchange-coupled spring magnets are described. For example, the hard magnet core (e.g., 30-100 nm in diameter) can be coated with a thin layer (e.g., 10-50 nm thick) of a high saturation moment soft magnet material. As previously described, the opposite configuration with a reversed arrangement of soft magnet core and hard magnet shell is also an option.

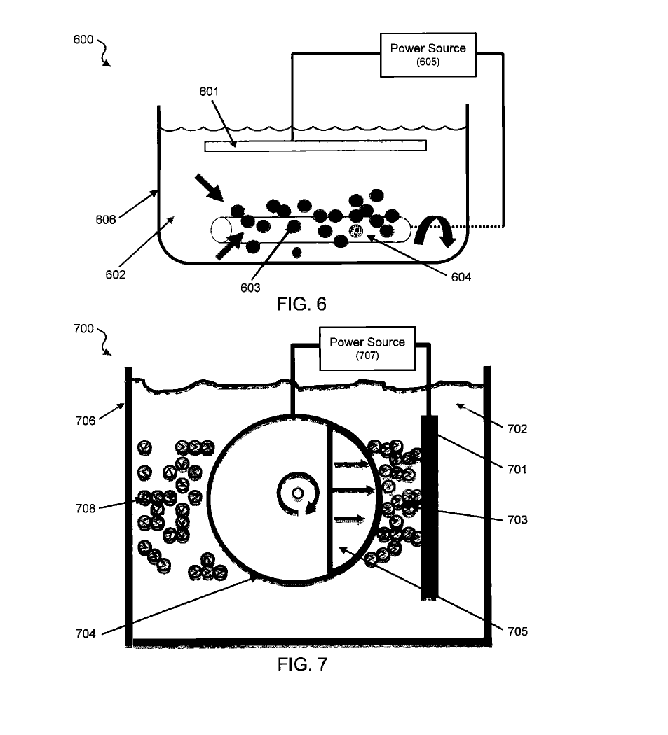

FIG. 6 shows a diagram of an exemplary electroplating bath configuration 600 of the disclosed technology using a rotating or moving cathode drum. The dissolved metal ions in the electrolyte solution are reduced on the cathode surface at the interface with the electrolyte, and the reduced metal is then deposited onto the cathode. For example, the exemplary electroplating bath configuration 600 can be used to implement electrodeposition of the exemplary coating layer of high magnetic moment, thin soft magnet material, e.g., including Fe_{0.65}CO_{0.35} alloy film on MnBi or MnAl alloy magnet nanoparticles. For example, the exemplary electroplating bath configuration 600 can include one or more electrodes to be rotated or shaken, or alternatively, the bottom electrode can stay still while the nanopowders are agitated and made to move around and make contact with the electrode.

As shown in FIG. 6, the exemplary electroplating bath configuration 600 can include an anode electrode 601 immersed in an electrolyte fluid 602 including the core magnet nanoparticles 603 contained in a container 606, the electrolyte fluid 602 also immersing a moving cathode electrode 604. The exemplary electroplating bath configuration 600 can include the anode electrode 601 in connection with a power source 605, the power source 605 also in connection with the moving cathode electrode 604. For example, for coating hard magnet nanoparticles (e.g., such as the spark eroded nanoparticles 207 formed of the exemplary hard magnet material 111), the anode electrode material 601 can include high saturation magnetization materials, e.g., including the exemplary soft magnet material 112 such as a Fe—Co alloy electrode or Pt electrode. For example, the electrolyte fluid 602 can be a sulfate, sulfamate, or acetate based solution (e.g., suitable for the exemplary Fe—Co alloy deposition). For example, the core magnet nanoparticles 603 can include MnBi, MnAl, or other high-coercivity magnetic nanopowders (e.g., which can be obtained or produced by spark erosion or other techniques previously described, such as pulverization, chemical precipitation, or atomization, among others). The exemplary core magnet nanoparticles 603 can be electroplated on contact with the moving cathode electrode 604 in the exemplary electroplating bath configuration 600. For example, the cathode electrode 604 can be made of electrically conductive metal or alloy materials and compounds, e.g., such as Ni, stainless steel, Pt, or other alloys and compounds. Additionally, for example, the exemplary electroplating bath configuration 600 can include techniques to promote particle separation, e.g., including, but not limited to, high pressure gas blast, ultrasonic stirring, or mechanical brushing, among other techniques.

The exemplary electroplating bath configuration 600 can be used to implement an electrodeposition process of a thin soft magnet material film (e.g., a Fe_{0.65}CO_{0.35} alloy film) on the exemplary hard magnet nanostructures (e.g., MnBi or MnAl alloy nanoparticles). The exemplary electrodeposition process can include moving (e.g., such as shaking and/or rotating) the cathode electrode 604, which can result in a high magnetic moment exhibited at the interface of the exemplary hard magnet nanostructures and the coated thin soft magnet material film.

Also for example, the exemplary electroplating technique can include electroplating using the exemplary moving drum cathode electrode (e.g., as shown in FIG. 6), e.g., rotating or shaking the cathode, and/or applying turbulent electrolyte movement, or by using jet stream-like force to make the hard magnet core nanoparticles come in contact with the cathode surface for brief time so that the particle surface can be cumulatively electroplated, e.g., by multiple touching, or by using a tray-shaped membrane collecting and pressing the magnet nanoparticles against the cathode surface so that the particles are coated during such pressing. The hard magnet nanoparticles electroplated with soft magnet shell (e.g., as shown in FIG. 6) can be collected from the exemplary bath container 606 by removing the electrolyte solution or by draining the coated nanoparticle slurry and washing, e.g., using alcohol for rapid drying.

FIG. 7 shows a schematic illustration of a cross-sectional view of an exemplary electroplating system 700 that includes mechanical agitation mechanisms to break up agglomerated nanoparticles and contact-enhancing mechanisms to coat exemplary permanent magnet core nanoparticles with soft magnetic materials. The exemplary electroplating system 700 can include an anode electrode 701 immersed in an electrolyte fluid 702 including the core nanoparticles 703 (e.g., such as the spark eroded nanoparticles 207 formed of the exemplary hard magnet material 111, including MnBi nanoparticles) contained in a container 706, the electrolyte fluid 702 also immersing a moving cathode electrode 704 to produce the exemplary core/shell nanostructures 708. The exemplary electroplating system 700 can be configured to have the anode electrode 701 in connection with a power source 707, and the power source 707 can also be connected with the moving cathode electrode 704. For example, the anode electrode 701 can include high saturation magnetization materials, e.g., such as a Fe—Co alloy electrode or Pt electrode. The exemplary cathode electrode 704 can be configured to include a contact enhance mechanism 705 to further control the coating of the exemplary soft magnet material over the core nanoparticles 703, produce the core/shell nanostructures 708 (e.g., Fe—Co coated MnBi nanoparticles). The exemplary contact enhancing mechanism 705 can include a DC or AC magnetic aligning mechanism, agitation mechanism, magnetic collection mechanism, drum vibration mechanism, brush contact metallic or plastic ribbon array mechanism, and/or other mechanisms or combinations thereof to enhance the contact of the exemplary core nanoparticles 703 with the anode electrode 701 while dispersing the nanoparticles). For example, the contact enhancing mechanism 705 can include an exemplary magnetic alignment mechanism that provides the means for the particles to be electrically in contact with each other, while mechanical agitation, brushing action and associated shear movement of the particles can rotate the core magnet particles 703 constantly to expose fresh surface area to the electrolyte for electroplating. For example, the electrolyte fluid 702 can be a sulfate, sulfamate, acetate based solution, or other suitable aqueous or organic solution for the exemplary soft magnet material coating. For example, the core nanoparticles 703 can be obtained or produced by spark erosion or other techniques previously described, such as pulverization, chemical precipitation, or atomization, among others).

For example, it is noted that nanoparticles with dimensions below certain limits may approach the superparamagnetic regime with undesirable consequence of weakening of the magnetic properties, e.g., if the particle size is below several nanometers, such as 5-10 nm in diameter. Therefore, for example, the core size can be configured to be in the range of 10-300 nm, and in some examples, range from 30-100 nm. Also, for example, the soft magnetic shell thickness can be configured to be in the range of 5-80 nm, and in some examples, range from 10-50 nm.

The described electroplating configurations of the disclosed technology (e.g., the electroplating bath configuration 600 of FIG. 6 or the electroplating system 700 of FIG. 7) can perform electroplating on isolated particle-shaped substrates, e.g., by using a rotating or moving cathode drum. For example, dissolved metal ions in the electrolyte solution can be reduced on the cathode surface at the interface with the electrolyte, in which the reduced metal can then deposited onto the cathode.

For example, since the deposition thickness of the coating can be very thin, (e.g., ˜20 nm thick), the exemplary electrodeposition process can be an ‘on-off’ cumulative deposition process implemented for these exemplary applications of exchange spring magnet fabrication techniques. For example, random contact deposition of the exemplary soft magnet alloy layer on the exemplary hard magnet nanoparticle surface can lead to a relatively uniform coating, e.g., after hundreds, or thousands of times of repeated contacts of the nanoparticles with the cathode surface. Alternatively, for example, the cathode electrode can be stationary and the core magnet nanoparticles (e.g., nanopowders) are agitated, e.g., by introduced turbulence in the electrolyte fluid so that the particles move around and frequently make contact with the cathode electrode for deposition of the magnet coating (e.g., the Fe—Co alloy material or other intended soft magnet material layer).

Yet, for example, another exemplary technique of electroplating the soft magnet material film on the loose, hard magnet nanostructures can include introducing a concave membrane (e.g., a cup-shaped, tray-shaped or other concave shaped structure) that can grab the loose, hard magnet nanopowders and force them to contact the cathode electrode with associated shear motion of the contacting nanoparticles. After some period of time, the exemplary membrane can allow the particles to release back into the electrolyte and grab another batch of the loose, hard magnet nanopowders from the electrolyte, thereby repeating the process. These exemplary cumulative steps of such scooping and coercing the exemplary nanopowders to contact the cathode surface can be repeated (e.g., in some examples at least 5 times, or in other examples, at least 20 times).

For example, since the single domain magnet nanoparticles are permanent magnet themselves, they tend to agglomerate by magnetic dipolar forces in addition to the van der Waals force agglomeration. Additional mechanical forces can be useful to at least momentarily break up the agglomeration to enable the surface coating with soft magnet layer. The disclosed technology can include exemplary agglomeration breakup mechanisms including ultrasonic agitation, gas pressure blow agitation, mechanical contact shear force agitation (e.g., brushing), among other mechanisms.

In addition to the particle agglomeration-breakup mechanisms, contact enhancing mechanisms can also be implemented to assist electrical contact of nanoparticles with the exemplary electrode surface for electrodeposition. The disclosed technology can include exemplary contact-enhancing mechanisms including DC or AC magnetic alignment and magnetic collection (e.g., exemplified in FIG. 7), drum vibration, brush-contact conductive metallic ribbon array, among other mechanisms. Exemplary contact-enhancing mechanisms can be applicable to many different types of core/shell exchange spring magnet synthesis techniques, e.g., including MnBi, MnAl, MnAlC, Ba/Sr-hexaferrites, rare earth cobalt or NdFeB type magnets, Fe-nitride magnets, L1₀ type magnets including Fe—Ni, FePt, CoPt, CoPd magnets, cobalt carbide magnets (e.g., Co₂C or Co₃C), or these magnets with alloying additions of Co and other elements, among others.

In some examples using iron group metals, the exemplary electroplating technique can include monitoring the iron group metals (Fe, Co, and Ni) during the electrodeposition, e.g. as the iron group metals may exhibit, under certain electroplating conditions, an anomalous co-deposition behavior of the less noble metal getting deposited preferentially to the more noble one.

The disclosed technology can include methods, systems, and devices for surface coating of floating magnet nanoparticles for core/shell structured exchange spring magnets, e.g., by physical vapor deposition.

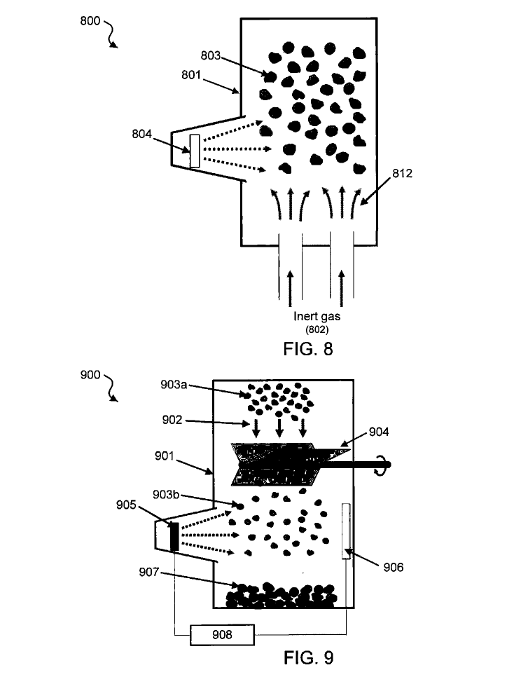

Exemplary coating methods using floating magnet nanoparticles (e.g., by physical or chemical vapor deposition techniques) to form core/shell exchange spring magnets of the disclosed technology are described in FIGS. 8-11. The exemplary physical or chemical vapor deposition coating methods can be applied to nanoparticles of materials including, but not limited to, MnBi, MnAl, MnAlC, Ba-/Sr-hexaferrites, rare earth cobalt or NdFeB type magnets, Fe-nitride magnets, L1₀ type magnets including Fe—Ni, FePt, CoPt, CoPd magnets, cobalt carbide magnets (e.g., Co₂C or Co₃C) or these magnets with alloying additions of Co and other elements.

The role of the fluidized bed/particle-dispersing apparatus includes coating the individual nanoparticles with the shell alloy material (e.g., Fe_{0.65}Co_{0.35}). Since the magnetic nanoparticles are ferromagnetic, magnetic agglomerations may also need to be minimized. The disclosed technology includes mechanisms to avoid or at least minimize magnetic particle agglomeration, e.g., by providing shear force of gas jets or mechanical dispersing, e.g. using high speed rotating blades in the chamber. For example, an exemplary fluidized bed can be operated at a warm temperature, e.g., near or above the Curie temperature (˜360° C. for MnBi, ˜385° C. for MnAl, and ˜300° C. for NdFeB magnet materials). The coated hard magnet processed at such a temperature may not possess the right alloy phase or crystal structure, and hence it may be necessary to provide additional annealing at lower temperature to obtain the desired phase stability, e.g., at 262° C. or below to obtain the low-temperature, hexagonal single phase MnBi having higher magnetic saturation.

FIG. 8 shows a schematic illustration of a fluidized bed apparatus 800 that can implement an exemplary process for coating the core magnet nanoparticles (e.g., MnBi or MnAl alloy nanoparticles or any hard magnetic alloy nanoparticles) with high magnetic moment alloy film (e.g., Fe_{0.65}Co_{0.35} alloy film or any other high magnetic moment alloy, such as Fe₁₆N₂). For example, the exemplary coating process can utilize the apparatus 800 in combination with physical vapor deposition or chemical vapor deposition. For example, the apparatus 800 can implement evaporating or sputtering deposition techniques of exemplary soft magnet material (e.g., Fe—Co alloy) film on floating hard magnet nanoparticles (e.g., MnBi or MnAl alloy particles), e.g., using interrupted gas flow versus coating deposition. For example, the apparatus 800 can implement the inert gas 802 into the fluidized bed 801 to suspend the exemplary floating hard magnet nanoparticles 803 (e.g., MnBi or MnAl alloy particles), e.g., at a low gas flow rate 812 (e.g., ˜25-50 SCCM). For example, the exemplary sputter target or evaporation target 804 can implement the sputtering or evaporating deposition techniques. For example, the exemplary floating hard magnet nanoparticles 803 can include MnBi or MnAl alloy particles (e.g., which can include ˜50-100 nm diameter). Also, for example, the fluidized bed 801 may also be used as a combined processing if desired.

FIG. 9 shows a schematic illustration of a fluidized bed and particle-dispersing apparatus 900 that can implement an exemplary process for coating the core magnet nanoparticles (e.g., MnBi or MnAl alloy core nanoparticles or any hard or soft magnetic alloy nanoparticles) with high magnetic moment alloy film (e.g., Fe_{0.65}Co_{0.35} alloy film shell or any other high magnetic moment alloy, such as Fe₁₆N₂). The particle-dispersing apparatus 900 can include a particle-dispersing (and floating) rotator 904 to disperse exemplary core magnet nanoparticles 903a under a flow of inert gas 902 in a fluidized bed 901 to generate floating magnet nanoparticles 903b. Alternatively, for example, intermittent gas blow from the base of the fluidized bed 901 can be used to disperse the particles to achieve the floating magnet nanoparticles 903b in the inert gas flow 902. For example, the inert gas 902 can be a low pressure inert gas (e.g., ˜10⁻² torr). For example, the exemplary floating magnet nanoparticles 903b can include MnBi or MnAl alloy particles or other hard magnet nanoparticles (e.g., which can include ˜50-100 nm diameter). A cathode 905 (e.g., sputter target, such as a Fe—Co sputter target (cathode), or evaporation target) positioned opposite an anode 906 in the fluidized bed 901 can implement sputtering or evaporating electrodeposition techniques to coat the exemplary floating magnet nanoparticles 903b with a coating layer (e.g., a high magnetic moment alloy material), in which the coated magnet nanoparticles 907 can be collected at a terminal end of the fluidized bed 901. For example, the exemplary anode 906 can be an independent electrode structure configured inside of the fluidized bed 901, or the exemplary anode 906 can be integrated as part of the chamber wall of the fluidized bed 901. For example, a power source 908 can be in connection with the cathode 905 and the anode 906. Also, for example, the fluidized bed 901 may also be used as a combined processing if desired. For example, the exemplary coating process can utilize the apparatus 900 in combination with physical vapor deposition or chemical vapor deposition, e.g., by implementing the particle-dispersing mechanism during physical vapor or chemical vapor deposition.

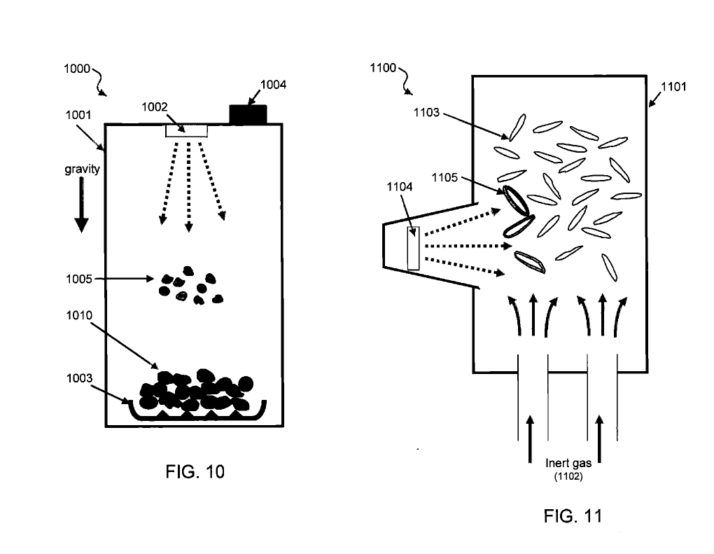

Exemplary sputter or evaporation coating techniques to create the disclosed core/shell structure from floating core nanoparticles and the exemplary soft magnet material coatings can include utilizing gravity as illustrated in FIG. 10. FIG. 10 shows a schematic illustration of an apparatus 1000 that can implement an exemplary far-away-sputtering technique for coating the core nanoparticles (e.g., MnBi or MnAl alloy magnet nanoparticles) with the high magnetic moment metallic film (e.g., Fe_{0.65}Co_{0.35} alloy film). For example, the exemplary far-away-sputtering technique can include placing the core nanoparticles at the bottom of a deposition chamber at a substantial distance from a sputtering source (e.g., such as at a 10 cm distance, or in other examples at 20 cm distance) and providing mechanical agitation or friction (e.g., utilizing a bumpy, rotating and/or vibrating tray) to cause the particles to rise (e.g., pop up) in the chamber, thereby allowing the coating material to be sputtered over the core particles while returning to the bottom of the deposition chamber. The apparatus 1000 can include a deposition chamber 1001 that can be placed under vacuum by a vacuum source 1004 (e.g., as a vacuum deposition chamber). For example, the exemplary vacuum 1004 in the chamber 1001 can be configured to maintain relatively low pressure for optimal sputtering or evaporation. The apparatus 1000 can include a sputtering source 1002 for deposition of the exemplary high saturation moment soft magnet layer (e.g., such as FeCo) with the particles positioned far below so that the gravity prevents the particles to be suctioned away by vacuum. The apparatus 1000 can include a particle tray 1003 that can be configured in a variety of shapes, e.g., which can include a rough or bumpy surface. For example, the particle tray 1003 can be configured to move by rotating, vibrating, or other motions, which can cause core nanoparticles 1005 to float in the deposition chamber 1001 and be coated by the exemplary sputtering source 1002 to form sputter coated hard magnet nanoparticles 1010 that can settle on the particle tray 1003, e.g., due to gravity. The apparatus 1000 can be configured to continuously replace the exemplary particle tray 1003 for faster production. For example, the exemplary vacuum 1004 in the chamber 1001 can be configured to maintain relatively low Ar pressure for optimal sputtering or evaporation, which could inadvertently suction the nanoparticles away. Therefore, the bottom positioning of the particle tray 1003 allows gravity to force the nanoparticles to stay near the bottom regions without getting suctioned away to the top region where the connection to the vacuum source 1004 is located during the soft magnet shell alloy deposition. In some examples, the apparatus 1000 can be configured as the apparatus 800 or the apparatus 900, in which the apparatus 1000 integrates the exemplary fluid bed and/or particle dispersing mechanisms into the deposition chamber 1001 (e.g., with the sputtering source 1002 and vacuum source 1004 at a substantial distance from a particle tray 1003 to permit gravity to act on the particles to settle on the tray after sputtering).

The soft magnet shell deposition techniques on floating magnet particles (e.g., as exemplified in FIGS. 8-10) can also be applied to non spherical nanoparticles, such as elongated shaped particles as illustrated in FIG. 11. FIG. 11 shows a schematic illustration of an apparatus 1100 that can implement an exemplary particle floating technique for coating of elongated magnet nanoparticles with soft magnet alloy. For example, the apparatus 1100 can implement an inert gas 1102 into a fluidized bed 1101 to suspend floating elongated nanoparticles 1103 for coating by a soft magnet layer to form shell-coated elongated magnet particles 1105. For example, the apparatus 1100 can include a sputter or evaporation source 1104 to implement the sputtering or evaporating deposition techniques, e.g., including soft magnet metal or alloy sputter coating or evaporation coating. For example, the exemplary elongated nanoparticles 1103 can include magnetic nanoparticles, as well as non-magnetic precursor particles or weakly magnetic precursor particles.

The exemplary core/shell exchange-coupled nanoparticles prepared according to the disclosed techniques described above can be utilized by further consolidating them with polymer or epoxy resin to form into a desired shape. Optionally, for example, during curing of the matrix polymer, a magnetic field can be applied to align the magnet particles along their easy direction of magnetization, so that a maximum (BH)ₘₐₓ value can be obtained. Also, for example, the relative volume fraction of the magnet particles versus the polymer matrix can be adjusted for desired magnetic and mechanical properties.

In another aspect, the disclosed technology can include methods, systems, and devices for pressing fully-coated (or partly-coated) exchange-coupled magnets (e.g., configured as core/shell structures or well-mixed hard magnet nanoparticles embedded in soft magnet material (or, for example, soft magnetic nanoparticles surrounding the hard magnetic nanoparticles)).

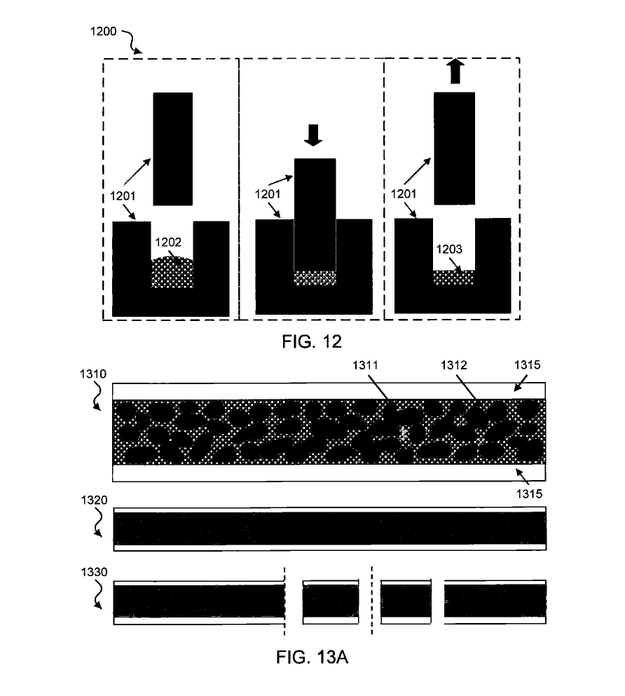

FIG. 12 shows a schematic illustration 1200 of a process to insert, press and sinter core-shell nanoparticles 1202 (e.g., MnBi hard magnet core coated with soft magnet shell) to form an exchange spring magnet 1203. For example, the exemplary press sintering process 1200 can be performed either by room temperature pressing followed by rapid sintering at higher temperature, or by pressing-consolidation at in situ warm or hot temperature. For example, rare earth-free MnBi alloy based permanent magnets can be consolidated into solid magnet geometry by pressing of the fully-coated (or partly-coated) core/shell particles 1202 (or well mixed nanoparticles of hard magnets surrounded by soft magnet nanoparticles) in a pressing die 1201 at room temperature or conducting warm temperature pressing (as illustrated in FIG. 12). For example, in order to minimize phase segregation during sintering anneal, heating to the warm pressing temperature can be conducted to a temperature less than 446° C. (e.g., and in some examples, less than 355° C. or even less than 262° C.) with the time at temperature also kept short, e.g., less than 30 minutes (e.g., and in some examples, less than 10 minutes in the case of an exemplary MnBi system). For example, the heating rate can be controlled to be relatively fast, e.g., at least 50° C./min, or in some examples, at least 100° C./min (e.g., such as by using spark plasma sintering or other rapid sintering means). Alternatively or additionally, exemplary nanopowders can be compressed into a pressed pellet followed by subsequent sintering anneal, e.g., using a fast heating and cooling. For example, an additional longer time anneal (e.g., at least 2 hrs) may be optionally administered at a low temperature, e.g., below 260° C., for additional homogenization of the alloy composition. The exemplary processed MnBi permanent magnet can exhibit coercive force (Hₑ) of at least 2 KOe at room temperature (and in some examples, at least 5 KOe, or even at least 7 KOe). For example, the exemplary processed MnBi permanent magnet can exhibit a high coercive force of more than 12 KOe at a temperature of 113° C. Also, for example, the room temperature energy product BHₘₐₓ of the exemplary MnBi exchange spring magnets can be made to be at least 10 MGOe (and in some examples, at least 20 MGOe, or even at least 30 MGOe).

In another aspect, the disclosed technology can include methods, systems, and devices for metal jacketed plastic deformation, e.g., for co-deformation, creation of fresh-surface metallic bonding, and consolidation of hard magnet powder and soft magnet powder in nano dimensions.

For example, jacketed magnet fabrication processes are illustrated in FIGS. 13A and 13B. The exemplary methods may be implemented in a way that can be amenable to high-throughput manufacturing. In the exemplary method (schematically illustrated in FIG. 13A), hard magnet nanopowders (e.g., MnBi or MnAl or other hard magnet materials) are fabricated, e.g., by methods such as the exemplary spark erosion techniques, or other methods including atomization, mechanical pulverization, chemical precipitation, etc. Subsequently, the hard magnet nanopowders are mixed thoroughly with soft magnetic alloy nanoparticles (e.g., Fe_{0.65}Co_{0.35} or elemental Fe or other soft magnetic material). In some examples, an oxidized version of Fe_{0.65}Co_{0.35} or Fe nanoparticles can also be utilized in a jacketed deformation and consolidation followed by reducing the oxides to metallic state by annealing heat treatment in a forming gas or hydrogen gas atmosphere. These exemplary mixed hard-soft nanopowders are then inserted into a casing such as a metal jacket (e.g., such as Cu, Fe, Ni, stainless steel, or other alloys), for example, in an inert atmosphere (e.g., Ar, N₂, etc). The jacket ends are sealed and the exemplary jacketed material preforms are then subjected to plastic deformation (e.g., such as cold rolling, warm rolling, hot rolling, swaging, extrusion, or other deformation techniques). The deformed jacket preform (e.g., including elongated/flaked and aligned hard magnet alloy particles/flakes coated with smeared or particle-layered soft magnet) can then be optionally annealed for additional consolidation and interface optimization, e.g., at 200-700° C. The long plate or rod of deformed preform can then be sliced to a desired size and magnetized for use as high strength magnets, e.g., either with the jacket left-over as a partially protective surface or with the jacket removed (e.g., by light etching). For example, the exemplary annealing treatment at 200-700° C. can be applied either before or after the slicing of the deformed preform to desired magnet sizes.

For example, uniaxial plastic deformation flattens and elongates exemplary MnBi nanoparticles or exemplary MnAl nanoparticles via particle fracture into flake geometry intermetallic compounds. For example, the exemplary MnBr or MnAl nanoparticles are generally brittle since hcp structured alloys tend to exhibit anisotropic mechanical fracture properties, but higher temperature deformation can cause plastic deformation. For example, a continued rolling or swaging process may be used to mechanically align the flakes along the deformation direction. In magnetic alloys with anisotropic magnetocrystalline anisotropy, an alignment of the magnetic material along the easy direction of magnetization (e.g., c-axis for MnBi) can be utilized to obtain a higher energy product, (BH)ₘₐₓ. Also for example, the uniaxial deformation can also flatten the more ductile Fe—Co alloy nanoparticles and smears/compresses them onto the MnBi flakes. The compressive deformation nature can aid in inducing strong atomic bonding between the MnBi magnet particle surface and Fe—Co alloy surface in contact with the MnBi type core surface.

FIG. 13A shows an exemplary diagram to produce elongated and aligned exchange-coupled spring magnets in bulk form. An exchange-coupled spring magnet 1310 can include hard magnet nanoparticles 1311 (e.g., such as MnBi or MnAl nanoparticles) embedded in a soft magnetic material 1312 (e.g., Fe—Co alloy layer coating) that is embedded in a metal jacket material 1315. For example, the metal jacket material 1315 can include metals and/or alloys including Cu, Fe, or stainless steel, among other metal materials. The exemplary exchange-coupled spring magnet 1310 can be processed using deformation techniques to form an elongated and aligned exchange-coupled spring magnet 1320 formed by uniaxial deformation, e.g., such as cold rolling, warm rolling, hot rolling, swaging, extrusion, or other deformation techniques. For example, the elongated and aligned exchange-coupled spring magnet 1320 in FIG. 13A shows the exemplary elongated/flaked aligned hard magnet alloy (e.g., MnBi, MnAl or other hard magnets) within a soft magnetic material (e.g., with Fe—Co nanoparticles or smeared Fe—Co alloy material), e.g., which can be optional annealed at temperatures (e.g., in a range of 200-700° C.) for consolidation and interface optimization. The exemplary elongated and aligned exchange-coupled spring magnet 1320 can be segmented into sliced elongated and aligned exchange-coupled spring magnet 1330.

An alternative method of jacketed preform fabrication of exchange-coupled magnet can include using core/shell particles, which may allow for more accurate control of the nanoscale dimensions of the exchange-coupled magnets, e.g., including making the soft magnet layer more uniform. The core/shell dimensions in this case can be made larger in consideration of the deformation-induced reduction in layer thickness. This exemplary method is schematically illustrated in FIG. 13B.

FIG. 13B shows an exemplary diagram of an elongated and aligned exchange-coupled spring magnet 1350 in bulk form. An exchange-coupled spring magnet 1350 can include a composite perform material comprising core/shell nanostructures 1351 (e.g., formed of core nanoparticles of the hard magnet material 111 surrounded by a shell coating of the soft magnet material 112) that are embedded in a metal jacket material 1355. For example, the metal jacket material 1355 can include metals and/or alloys including Cu, Fe, Ni, or stainless steel, among other metal materials. Also, for example, the exemplary composite preform material can be filled with reducing or inert gas. The exemplary exchange-coupled spring magnet 1350 can be processed using deformation techniques to form an elongated and aligned exchange-coupled spring magnet 1360 formed by uniaxial deformation, e.g., such as cold rolling, warm rolling, hot rolling, swaging, extrusion, or other deformation techniques. For example, the elongated and aligned exchange-coupled spring magnet 1360 in FIG. 13B shows the exemplary elongated and aligned core/shell nanoparticles (e.g., MnBi or MnAl core/Fe_{0.65}Co_{0.35} shell), e.g., which can be optionally annealed and sintering (e.g., in a range of 200-700° C.) for consolidation and interface optimization. The exemplary elongated and aligned exchange-coupled spring magnet 1360 can be segmented into sliced elongated and aligned exchange-coupled spring magnet 1370. For example, the exemplary elongated and aligned exchange-coupled spring magnet 1360 can be sliced to a desired size and magnetized for use as high strength magnets, e.g., either with the jacket left-over as a partially protective surface or with the jacket removed (e.g., by light etching). For example, the exemplary annealing treatment at 200-700° C. can be applied either before or after the slicing of the deformed preform to desired magnet sizes.

For example, an alternative processing technique can include conducting the uniaxial deformation by warm rolling or hot rolling at 200-600° C., providing more ductile behavior of the exemplary MnBi or MnAl alloy particles to allow some plastic deformation and texture formation. For example, the deformed nanocomposite alloy can undergo further heat treatment at low temperature below 300° C., and in an inert or reducing atmosphere, e.g., to restore the phase stability to the desired phase, such as the low temperature phase MnBi. Exemplary rolling or swaging deformation can also reduce the thickness of both the hard magnet core and the soft magnet shell. In some examples, the diameter of the starting powder of the core/shell nanostructures 1351 inserted into the metal jacket 1355 can be configured to be substantially large, which may allow for easier and more flexible processing. For example, a final deformation configuration that includes a 50 nm core thickness with a 20 nm soft layer can be produced by utilizing 200 nm thick MnBi or MnAl core nanoparticles with 80 nm soft magnet layer as the beginning core/shell nanoparticles. And for example, plastic deformation by rolling or swaging can reduce the thickness of the jacketed composite preform by a factor of roughly ˜4, e.g., from 10 cm thickness to ˜2.5 cm thickness.

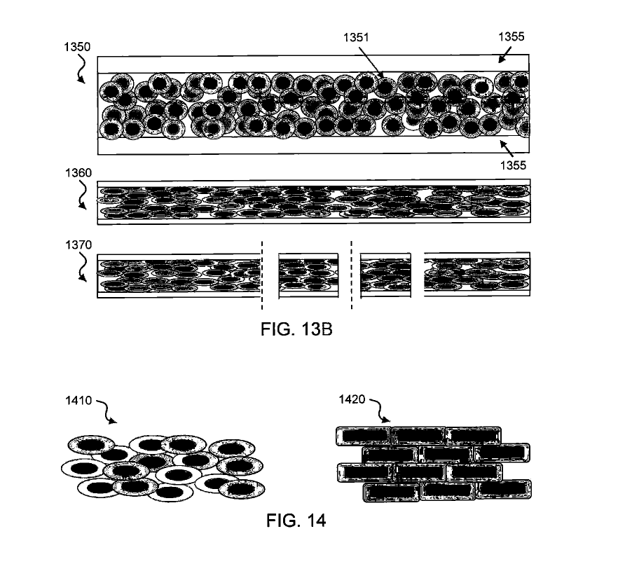

Exemplary compressive plastically deformed or uniaxially deformed exchange-coupled magnets are shown in FIGS. 13A and 13B (e.g., using a ductile metal jacket) and FIG. 14, e.g., demonstrating further enhanced compaction and densification of the disclosed exchange-coupled magnets. For example, exemplary compressive plastic deformation or uniaxial deformation processes can be used for densification, as well as to provide anisotropic grain structure of the fabricated exchange-coupled magnets. For example, the amount of compressive plastic deformation or uniaxial deformation can be configured to at least 20% reduction in cross-sectional area, and in some examples, at least 40% reduction in cross-sectional area. The uniaxially deformed material of the disclosed magnet material can exhibit an elongated nanograin structure along the deformation direction, e.g., with an average aspect ratio of elongated grains of at least 1.5.1, and in some examples of plastic deformed grains, at least 3:1.

For example, in the case of less plastic deformation, the nanoparticles would tend to undergo a nanofragmentation-type fracture (e.g., instead of a plastic deformation for elongated grain geometry. An exemplary case of less plastic deformation can include a situation with a room temperature or sub-room temperature deformation of a jacked nanocomposite material containing room temperature brittle intermetallic compounds, e.g., rather than a substantially warmer temperature deformation which would produce more plastic deformation. In such a situation, the amount of deformation to be provided can still be expressed in a similar manner, e.g., the amount of compressive plastic deformation or uniaxial deformation can be configured to at least 20% reduction in cross-sectional area, and in some examples, at least 40% reduction in cross-sectional area. The uniaxially deformed material of the disclosed magnet material can exhibit an elongated nanograin structure along the deformation direction, e.g., with an average aspect ratio of elongated grains of at least 1.5:1, and in some examples of plastic deformed grains, at least 3:1.

For example, the disclosed deformation techniques include a clean, atomic scale bonding at the surface interface between hard magnet material and soft magnet material in contact as a shell or as a generally coated configuration to produce exchange spring magnets. Mechanical deformation (e.g., plastic deformation, shear, or fracture) of the described hard magnet material within the described soft magnet material can create a fresh unoxidized surface for metallic interfacial bonding. For example, round, rectangular, or other shaped jackets can be utilized. The exemplary processing techniques are applicable to many different types of core/shell exchange spring magnets, e.g., including those having hard magnet materials such as MnBi, MnAl, MnAlC, Ba-hexaferrites, Sr-hexaferrites, rare earth cobalt or NdFeB type magnets, Fe-nitride magnets, L1₀ type magnets including Fe—Ni, FePt, CoPt, CoPd magnets, cobalt carbide magnets (e.g., Co₂C or Co₃C) or these magnets with alloying additions of Co and other elements.

In another example, a rare earth-containing composition (e.g., including dysprosium (Dy) or other rare earth materials such as NdFeB) of magnet nanoparticles can be mixed with nonmagnetic grain boundary decorating metal nanoparticles (e.g., including Cu, Ag, Zn, Si, Sn, Sb, Bi, Mg, Al, other transition metals, or rare earth and their alloys), as described later in this patent document. This exemplary mixed material can be plastically deformed in one or more of the exemplar manners previously described for such intimate nanocomposite mixing to maximize domain wall pinning defects density and cleanness.

The degree of compaction of core/shell nanocomposite material can be considered an important factor for determining the overall energy product of the exchange spring magnet. FIG. 14 shows schematic illustrations of core/shell magnet compaction by plastic deformation. FIG. 14 shows a schematic 1410 of an exemplary exchange spring magnet material formed by plastic deformation including swaging for partly compacted configuration and annealing. FIG. 14 also shows a schematic 1420 of an exemplary exchange spring magnet material formed by plastic deformation including swaging for further compaction to a higher density and annealing. For example, further deformation can be achieved within the jacketed configuration, which can increase the density of the magnetic material toward higher energy products, and may also induce stronger interfacial bonding of core magnet material and soft magnet shell layer for enhanced exchange bias interaction. For example, an exemplary core/shell exchange spring magnet can be configured with a degree of compaction of at least 70% density (less than 30% pores), and in some examples, of at least 90% to 95% density (less than 10% to 5% pores).

The described exchange interaction spring magnets illustrated in FIGS. 12-14 can exhibit significantly improved permanent magnet properties, e.g., particularly by employing the disclosed spark erosion techniques to produce the nanoparticles. For the rare earth-free MnBi alloy system, for example, the permanent magnets of the disclosed technology can be consolidated into a solid magnet geometry. For example, these consolidated permanent magnets can exhibit H_{c} of at least 2 KOe at room temperature (and in some examples, at least 5 KOe, or even at least 7 KOe). The room temperature energy product BHₘₐₓ of the exemplary MnBi exchange spring magnets can be made to be at least 10 MGOe (and in some examples, at least 20 MGOe, pr even at least 30 MGOe).

In another aspect, the disclosed technology can include methods, systems, and devices for chemical decoration of the hard magnet nanoparticle surface with soft magnet ions or nanoparticles through surface modifications with functionalization.

For example, exchange bias spring magnets of the disclosed technology can also be prepared by surface decoration of hard magnet nanoparticles with smaller diameter soft magnet particles, instead of continuous layer. An exemplary chemical decoration technique can include functionalization of hard magnet particle surface (e.g., of MnBi or MnAlC nanoparticles, or other materials of the hard magnet material 111) using soft magnet ions or nanoparticles, e.g., through surface modifications, and optionally, for example, self assembly of coated nanoparticles. The exemplary chemical decoration technique can also include mechanical deformation subsequent to the exemplary functionalization process, the mechanical deformation process including pressing, rolling, swaging, extrusion, rod drawing, or other deformation techniques to locally flatten and enhance atomic contact of the exemplary hard magnet base and the exemplary soft magnet coating. In some examples, the coating provided by the soft magnet ions or soft magnet nanoparticles is not necessarily continuous.

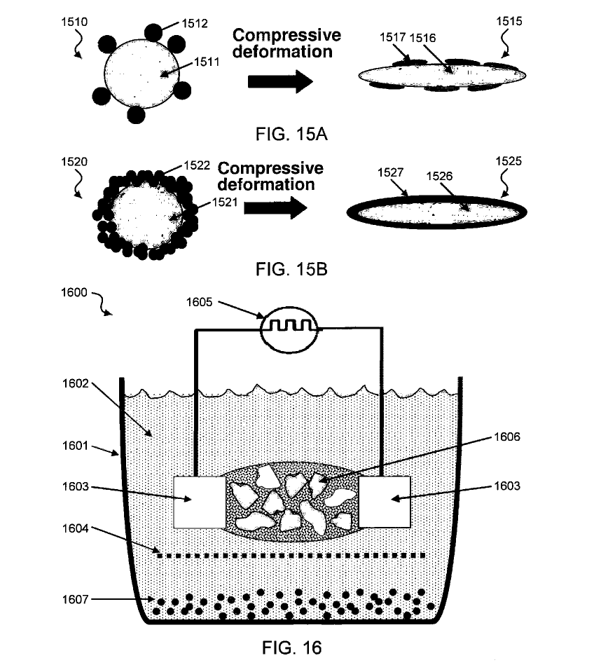

FIGS. 15A and 15B show schematic illustrations of exemplary hard magnet nanoparticle surface coatings with smaller diameter soft magnet nanoparticles, designed to produce core/shell exchange-coupled magnets by using compressive deformation. For example, FIG. 15A shows a structure 1510 that includes a hard magnet nanoparticle 1511 partially coated with soft magnet nanoparticles 1512, and the structure 1510 undergoes compressive deformation to produce a structure 1515, which includes an elongated hard magnetic material 1516 partially coated by the soft magnetic material coating 1517. Also example, FIG. 15B shows a structure 1520 that includes a hard magnet nanoparticle 1521 fully coated (e.g., multi-layered) with soft magnet nanoparticles 1522, and the structure 1520 undergoes compressive deformation to produce a structure 1525, which includes an elongated hard magnetic material 1526 fully coated by the soft magnetic material coating 1527.

The exemplary chemical decoration processing can be applicable to many different types of core/shell exchange spring magnet synthesis including, but not limited to, MnBi, MnAl, MnAlC, Ba-/Sr-hexaferrites, rare earth cobalt or NdFeB type magnets, Fe-nitride magnets, L1₀ type magnets including Fe—Ni, FePt, CoPt, CoPd magnets, cobalt carbide magnets (e.g., Co₂C or Co₃C) or these magnets with alloying additions of Co and other elements.

For example, the exemplary core magnet particle diameter (e.g., hard magnets) can be configured in the range of 10-300 nm, and in some examples, in the range of 30-100 nm. The smaller coating particles (e.g., soft magnets) can be configured to have smaller diameters in the range of 5-80 nm, and in some examples, in the range of 10-50 nm. In the case of partial surface coverage as in FIG. 15A, the exemplary surface coverage fraction by soft magnet layer after compressive or uniaxial deformation can be configured based on the degree of surface coverage. In some examples, this can be controlled to at least 20%, or in other examples, this can be controlled to at least 50%. In the case of multi-layer particle coating of FIG. 15B, the exemplary surface coverage fraction can be controlled to at least 90% coverage after the deformation, or in some examples, to a lesser degree of coverage as desired (e.g., such as at least 60%).

The described exchange interaction spring magnets illustrated in FIGS. 15A and 15B can exhibit significantly improved permanent magnet properties, e.g., particularly by employing the disclosed spark erosion techniques to produce the nanoparticles. For the rare earth-free MnBi alloy system, for example, the permanent magnets of the disclosed technology can be consolidated into a solid magnet geometry. For example, these consolidated permanent magnets can exhibit H_{c} of at least 2 KOe at room temperature (and in some examples, at least 5 KOe, or even at least 7 KOe). The room temperature energy product BHₘₐₓ of the exemplary MnBi exchange spring magnets can be made to be at least 10 MGOe (and in some examples, at least 20 MGOe, pr even at least 30 MGOe).

In another aspect, the disclosed technology can include methods, systems, and devices for spark erosion using a nano-dispersoid dielectric medium, e.g., containing metallic or ceramic nanoparticles, dissolved salts, or dissolved cations or anions, to produce nanocomposited alloy powders during sparking.

The disclosed technology can include techniques to synthesize the nanostructures having the disclosed core/shell configuration by conducting spark erosion using a nano-dispersoid dielectric medium already containing dispersed metallic or precursor compound nanoparticles, dissolved salts, or dissolved cations or anions, to produce nanocomposite structured alloy powder during sparking. For example, the exemplary nano-dispersoid dielectric media can contain soft magnet nanoparticles (e.g., Fe, Co, Ni and their alloys), non-magnetic or magnetic precursor nanoparticles of salt or organic compound containing Fe, Co, Ni (e.g., Fe—Co chloride), Fe-oxide or (Fe,Co)-oxide nanoparticles, or aqueous or organic solution containing dissolved cations of Fe, Co, Ni, and some anions for spark erosion in a base medium of liquid N₂, liquid Ar, water, or dodecane type hydrocarbon liquid (C₁₂H₂₆)]. For example, the exemplary precursors can be decomposed later by annealing in vacuum or in reducing atmosphere such as forming gas or hydrogen gas atmosphere, e.g., to convert the precursor material into the final desired metallic material. The described spark erosion processing techniques for producing sparked nanoparticles inside a dielectric liquid with predispersed nanoparticles can be applicable to many different types of core/shell exchange spring magnet synthesis including, e.g., including, but not limited to, MnBi, MnAl, MnAlC, Ba/Sr-hexaferrites, rare earth cobalt or NdFeB type magnets, Fe-nitride magnets, L1₀ type magnets including Fe—Ni, FePt, CoPt, CoPd magnets, cobalt carbide magnets (e.g., Co₂C or Co₃C) or these magnets with alloying additions of Co and other elements.

FIG. 16 shows a schematic illustration of a spark erosion apparatus 1600 that uses a nano-dispersoid dielectric medium containing metallic or precursor compound nanoparticles, dissolved salts, or dissolved cations or anions to produce nanocomposite structures during sparking (e.g., nanoscale structured alloy nanocomposite powder). The exemplary spark erosion apparatus 1600 can be implemented in a manner similar to that previously described and shown in FIG. 2. As shown in FIG. 16, the spark erosion apparatus 1600 can include a container 1601 that contains a nano-dispersoid dielectric fluid 1602, e.g., such as liquid N₂, liquid Ar, water, or dodecane type hydrocarbon liquid (C₁₂H₂₆). The exemplary nano-dispersoid dielectric fluid 1602 includes dispersed compounds or substances with bulk charge pieces 1606. For example, the dispersed substances can behave as spacer particles, and can be configured as nanoparticles such as magnetic domain wall pinning nanoparticles, metallic or precursor compound nanoparticles, dissolved salts, or dissolved ions (e.g., which can be of a nonmagnetic or soft magnetic material). The exemplary spark erosion apparatus 1600 can include shaker pot electrodes 1603 in connection to a pulsed power source 1605, e.g., to implement a spark erosion process in an exemplary manner as previously described. For example, electric fields can be generated in the gaps existing among the electrodes 1603 and the bulk charge pieces 1606. For example, as described previously, microplasmas (sparks) can be generated in these exemplary gaps, e.g., when the electric field in a gap is greater than the breakdown field of the dielectric. For example, when the spark collapses, tiny structures (e.g., in the form of molten droplets and/or vaporized material which can be of a nanoscale size) can be ejected into the dielectric, e.g., in which the tiny structures are rapidly quenched/condensed. In some configurations, the exemplary spark erosion apparatus 1600 can include vibrating mechanisms, e.g., by using a shaker-pot configuration, or in some examples, a rotating-electrodes configuration. For example, the exemplary metallic or precursor compound nanoparticles, dissolved salts, or dissolved ions of nonmagnetic materials or soft magnetic materials, which can be referred to as spacer particles (e.g., spacer nanoparticles). The exemplary with charge pieces 1606 can be introduced into the nano-dispersoid dielectric fluid 1602 and made to come closer to the exemplary shaker pot electrodes 1603, e.g., by mechanical vibrations such as the rotation of the electrodes 1603. Implementations of the exemplary spark erosion apparatus 1600 can be performed to produce spark eroded nanocomposite structures 1607 that can be collected on the other side of a screen 1604 within the container 1601. For example, the exemplary spark eroded nanocomposite structures 1607 can pass through a perforated mounting screen 1604 located at an end (e.g., the bottom) of the exemplary spark erosion apparatus 1600, in which the exemplary spark eroded nanocomposite structures 1607 can be subsequently collected and processed. For example, the exemplary spark eroded nanocomposite structures 1607 can be mixed with the spacer nanoparticles that can diffuse throughout the dielectric fluid 1602 and inhibit agglomeration of the spark eroded nanocomposite structures 1607 prior to collection and/or subsequent processing. For example, these exemplary mixed nanostructures can be subsequently consolidated by pressing, jacketed deformation, etc, and annealed in inert gas atmosphere or in reducing atmosphere to help decompose any precursor nanoparticles or layers.

For example, the desired amount of dispersed nanoparticles floating in the dielectric medium for the FIG. 16 type spark erosion method can be configured to at least 0.2 volume %, or in other examples, to at least 1 volume %, or in other examples to at least 5 volume % of the dielectric liquid used for spark erosion run. The desired amount of the trapped soft magnet nanoparticles as a part of the nanocomposite structure, after removal of the dielectric medium (e.g., by evaporation of liquid nitrogen medium), can be configured to at least 10 volume %, and in some examples at least volume 30%.

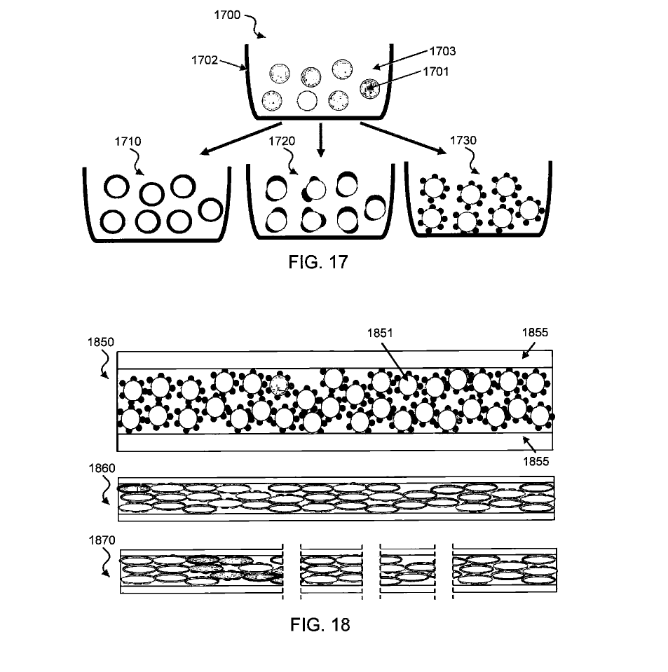

Implementing the disclosed spark erosion techniques in the exemplary dielectric liquid containing dispersed metallic or oxide nanoparticles, or precursor compounds or ions can engineer different configurations of the soft magnet coating or second phase material coating. For example, spark erosion of the magnet nanoparticles occurs in the immersed state within the dielectric liquid already containing the soft magnet nanoparticles or magnetic-domain-wall pinning nanoparticles or their precursor particles (e.g., to improve the hard magnet properties through increased coercive force in consolidated magnet material). Therefore, for example, when the spark eroded magnet nanoparticles are retrieved from the dielectric liquid (e.g., after evaporation of liquid nitrogen if it is the dielectric medium used), the magnet nanoparticles are already surrounded by soft magnetic or domain-wall-pinning nanoparticles. Three exemplary structures that can be fabricated using these techniques are shown in FIG. 17, e.g., which include fully decorated core/shell particles, partially core-shell decorated particles, and island-type surface decorated particles.

FIG. 17 shows schematic illustrations of spark erosion processing to produce different configurations of soft magnet coatings or second phase material coatings. A schematic 1700 shows exemplary spark eroded hard magnetic alloy particles 1701 without surface decoration in a container 1702 filled with dielectric liquid 1703 containing, for example, dispersed metallic nanoparticles, oxide nanoparticles, precursor compounds or precursor ions to produce different coatings. For example, FIG. 17 demonstrates in situ surface coating decoration of the hard magnet nanoparticle surface during spark erosion using nano-layer or nanoparticle materials that include, for example, ceramic (e.g., oxide, nitride, fluoride, carbide, carbon, graphite, etc.), metallic (e.g., Ag, Cu, Si, Bi, Sb, Sn, Mg, Ca, transition metal, rare earth, etc.) or precursor substances (e.g., chloride, fluoride, etc) materials, by using chemical-containing or particle-containing dielectric medium for spark erosion. The exemplary spark eroded hard magnetic alloy particles 1701 can be coated by chemical decoration using at least one of the exemplary surface coating configurations illustrated in the following schematics. For example, a schematic 1710 shows core-shell decorated particles with soft magnet material (or precursor of soft magnet) by spark erosion. For example, a schematic 1720 shows partially decorated core-shell particles with soft magnet material by spark erosion. For example, a schematic 1730 shows soft magnet material island-type surface decorated particles by spark erosion.

For example, all of these exemplary structures can be useful for producing exchange spring magnets with a different degree, e.g., by consolidating these coated particles, either in a compressed form or in a metal jacketed configuration, with plastic deformation (FIG. 18) and additional annealing, decomposition of compound materials, or reduction heat treatment as needed for each type of materials involved. For example, elongated and aligned MnBi type magnet phase and Fe—Co alloy type soft magnet phase can be obtained based on the temperature of the plastic deformation.

FIG. 18 shows an exemplary diagram demonstrating consolidation of exemplary core/shell nanoparticles produced by exemplary spark erosion techniques (e.g., within dielectric containing dispersed soft magnet or its precursor nanoparticles or ions) by compressive deformation, e.g., including rolling or swaging to form elongated and aligned exchange-coupled magnets. For example, FIG. 18 shows an exchange-coupled spring magnet 1850 formed of a composite perform material that includes core/shell nanostructures 1851 (e.g., formed of core nanoparticles of the hard magnet material 111 coated with smaller-sized soft magnetic nanoparticles) e.g., such as the particles shown in the schematics 1710, 1720, and 1730 of FIG. 17, that are embedded in a metal jacket material 1855. For example, the metal jacket material 1855 can be configured as a metal and/or alloy tube jacket including Cu, Ni, Fe, or stainless steel, among other metal materials. Also, for example, the exemplary composite preform material can be filled with reducing or inert gas. The exemplary exchange-coupled spring magnet 1850 can be processed using compressive deformation techniques to form an elongated and aligned exchange-coupled spring magnet 1860, e.g., by implementing deformation techniques such as rolling or swaging, or other deformation techniques. For example, the elongated and aligned exchange-coupled spring magnet 1860 in FIG. 18 shows the exemplary elongated and aligned core/shell nanoparticles (e.g., anisotropically aligned MnBi or MnAl core/Fe_{0.65}Co_{0.35} shell of smaller-sized soft magnetic nanoparticles), e.g., which can be optionally annealed (e.g., in a range of 200-700° C.) for consolidation and interface optimization. The exemplary elongated and aligned exchange-coupled spring magnet 1860 can be segmented into sliced elongated and aligned exchange-coupled spring magnet 1870. For example, the exemplary elongated and aligned exchange-coupled spring magnet 1860 can be sliced to a desired size and magnetized for use as high strength magnets. For example, an exemplary consolidation annealing treatment at 200-700° C. may also be applied after the slicing.

The described exchange interaction spring magnets illustrated in FIGS. 16-18 can exhibit significantly improved permanent magnet properties, e.g., particularly by employing the disclosed spark erosion techniques to produce the nanoparticles. For the rare earth-free MnBi alloy system, for example, the permanent magnets of the disclosed technology can be consolidated into a solid magnet geometry. For example, these consolidated permanent magnets can exhibit H_{c} of at least 2 KOe at room temperature (and in some examples, at least 5 KOe, or even at least 7 KOe). The room temperature energy product BHₘₐₓ of the exemplary MnBi exchange spring magnets can be made to be at least 10 MGOe (and in some examples, at least 20 MGOe, pr even at least 30 MGOe).

In another aspect, the disclosed technology can include methods, systems, and devices for spark erosion using composite electrodes containing separate hard magnet and soft magnet phases.

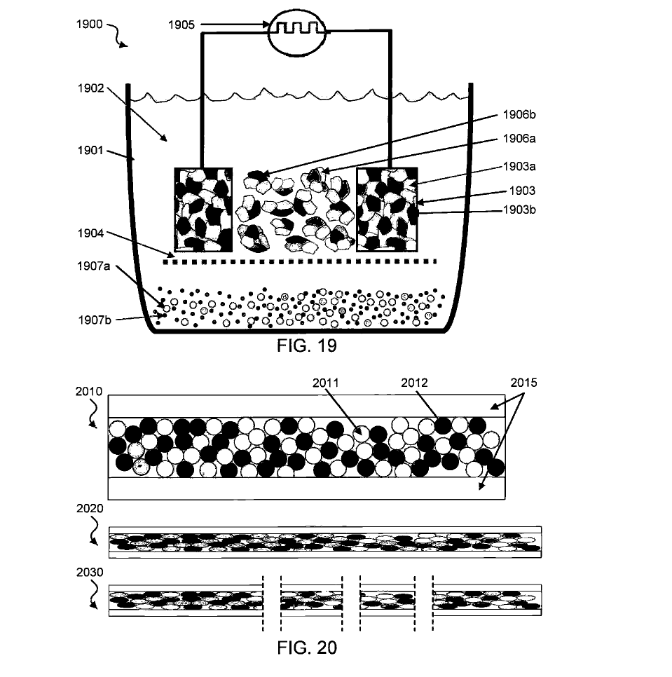

For example, the disclosed technology can be used to enable a better mixing of hard magnet nanoparticles and soft magnet nanoparticles before they agglomerate, e.g., by implementing the described spark erosion techniques using composite electrodes containing hard magnet and soft magnet phases as illustrated in FIG. 19. FIG. 19 shows a schematic illustration of a spark erosion apparatus 1900 that uses composite electrodes 1903 containing hard magnet phases 1903a and soft magnet phases 1903b, e.g., which can be made by compositing methods with minimal diffusion involved and by avoiding alloying of hard magnet elements with soft magnet elements. The exemplary spark erosion apparatus 1900 can be implemented in a manner similar to that previously described and shown in FIG. 2. For example, the spark erosion apparatus 1900 can include a container 1901 that contains a dielectric fluid 1902 (e.g., such as liquid N₂, liquid Ar, or water) and the spark erosion composite electrodes 1903 in connection to a pulsed power source 1905, e.g., to implement a spark erosion process in an exemplary manner as previously described. For example, electric fields can be generated in the gaps existing among the composite material electrodes 1903 and bulk charge pieces 1906 dispersed in the dielectric media 1902. For example, the bulk charge pieces 1906 can include phases of hard magnetic and soft magnetic materials, e.g., each exemplary charge piece 1906 can also be formed of a hard magnet phase 1906a and a soft magnet phase 1906b. For example, the exemplary spark erosion electrodes 1903 and the charge pieces 1906 can be made by low temperature, rapid sintering of component nanoparticles, with minimal diffusion and by avoiding alloying of hard magnet elements with soft magnet elements. Exemplary starting materials of the exemplary electrodes 1903 and charge pieces 1906 can include a mixed phase microcomposite, e.g., including hard magnet phase materials (e.g., MnBi, MnAl, L1₀ type FePt, CoPt, CoPd, NiFe magnets, metal nitride magnets (e.g., Fe nitride), metal carbide magnet materials (e.g., Co carbide), or metal oxide magnet materials, among other hard magnet materials) and soft magnet phase materials (e.g., FeCo, Fe, Ni, Co, or amorphous soft magnet, among other soft magnet materials). For example, as described previously, microplasmas (sparks) can be generated in these exemplary gaps, e.g., when the electric field in a gap is greater than the breakdown field of the dielectric. For example, when the spark collapses, tiny structures (e.g., molten droplets and/or vaporized material which can be of a nanoscale size) can be ejected into the dielectric, e.g., in which the tiny structures are rapidly quenched/condensed. In some configurations, the exemplary spark erosion apparatus 1900 can include vibrating mechanisms, e.g., by using a shaker-pot configuration, or in some examples, a rotating-electrodes configuration. Implementations of the exemplary spark erosion apparatus 1900 can be performed to produce spark eroded mixture structures 1907a and 1907b that can be collected on the other side of a screen 1904 within the container 1901. For example, the spark eroded particles 1907a can include hard magnet phase particles (e.g., MnBi, MnAl, L1₀ type FePt, CoPt, CoPd, NiFe magnets, metal nitride magnets (e.g., Fe nitride), metal carbide magnet materials (e.g., Co carbide), or metal oxide magnet materials, among other hard magnet materials) that are mechanically mixed with the spark eroded particles 1907b (e.g., FeCo, Fe, Ni, Co, or amorphous soft magnet, among other soft magnet materials). Also, for example, NdFeB, Sm—Co hard magnet phase particles can be more uniformly mixed with smaller grain boundary barrier material phase particles (domain wall pinning phase), e.g., such as Cu, Ag, Zn, Si, Sn, Sb, Bi, Mg, Al, other transition metals, rare earth and their alloys in the spark erosion target material. In some examples, the spark eroded nanoparticles 1907a and 1907b can be alloyed with constituents of the single phase charge pieces and electrodes. The exemplary spark eroded mixture structures 1907 can pass through a perforated mounting screen 1904 located at an end (e.g., the bottom) of the exemplary spark erosion apparatus 1900, in which the exemplary spark eroded mixture structures 1907 can be subsequently collected and processed.

Referring to the FIG. 19, the exemplary composite spark erosion electrodes 1903 (targets) that contain hard magnet and soft magnet phases can be configured to a desired volume ratio of each phase of the composite two phase target of 40-80% hard magnet phase and 20-60% soft magnet phase. In some examples, desired volume ratio of each phase of the composite two phase target can be 50-70% hard magnet phase and 30-50% soft magnet phase. For example, the desired sizes of the hard magnet and soft magnet regions can be selected so as to minimize undesirable alloying of the hard magnet and soft magnet elements during spark erosion. Therefore an exemplary size range of the hard magnet and soft magnet phases in the composite target (the electrodes and the charge pieces) can be configured to a size of at least 100 μm, and in some examples, at least 300 μm.

Consolidation of the exemplary hard magnet and soft magnet mixed nanoparticles of FIG. 19 into a bulk usable magnet geometry can be implemented with sintering techniques, or alternatively for example, with compressive and uniaxial deformation techniques within a jacket, e.g., such as by cold rolling, warm rolling, extrusion, swaging, rod drawing, which can be followed by an annealing heat treatment, as illustrated in FIG. 20. For example, the exemplary elongated and aligned MnBi type magnet phase and Fe—Co alloy type soft magnet phase can be obtained based on the temperature of the plastic deformation.

FIG. 20 shows an exemplary diagram to produce elongated/flaked and aligned exchange-coupled spring magnets (e.g., in bulk form) by consolidation of hard magnet and soft magnet mixed nanoparticles produced by spark erosion techniques of the disclosed technology of composite-phase target material. For example, an exchange-coupled spring magnet 2010 can include hard magnet nanoparticles 2011 (e.g., such as MnBi or MnAl nanoparticles or other described exemplary hard magnet materials) and soft magnetic material 2012 (e.g., Fe—Co alloy or Fe or Co layer coating) that is embedded in a metal jacket material 2015. For example, the metal jacket material 2015 can include metals and/or alloys including Cu, Fe, or stainless steel, among other metal materials. The exemplary exchange-coupled spring magnet 2010 can be processed using deformation techniques to form a compacted or an elongated and aligned exchange-coupled spring magnet 2020 formed by compressive and uniaxial deformation, e.g., such as cold rolling, warm rolling, extrusion, swaging, rod drawing, or other deformation techniques. For example, the elongated and aligned exchange-coupled spring magnet 2020 in FIG. 20 shows the exemplary elongated/flaked aligned hard magnet alloy (e.g., MnBi, MnAl or other hard magnets) in contact with elongated/flaked aligned soft magnetic material (e.g., with Fe—Co nanoparticles or smeared Fe—Co alloy material), e.g., which can be optional annealed at temperatures (e.g., in a range of 200-700° C.) for consolidation and interface optimization. The exemplary elongated and aligned exchange-coupled spring magnet 2020 can be segmented into sliced elongated and aligned exchange-coupled spring magnet 2030.

The described exchange interaction spring magnets illustrated in FIGS. 19-20 can exhibit significantly improved permanent magnet properties, e.g., particularly by employing the disclosed spark erosion techniques to produce the nanoparticles. For the rare earth-free MnBi alloy system, for example, the permanent magnets of the disclosed technology can be consolidated into a solid magnet geometry. For example, these consolidated permanent magnets can exhibit H_{c} of at least 2 KOe at room temperature (and in some examples, at least 5 KOe, or even at least 7 KOe). The room temperature energy product BHₘₐₓ of the exemplary MnBi exchange spring magnets can be made to be at least 10 MGOe (and in some examples, at least 20 MGOe, pr even at least 30 MGOe).

In another aspect, the disclosed technology can include methods, systems, and devices for synthesis of core magnet particles by using a triple core-shell-shell structure, e.g., which can be used to avoid magnetic agglomeration.

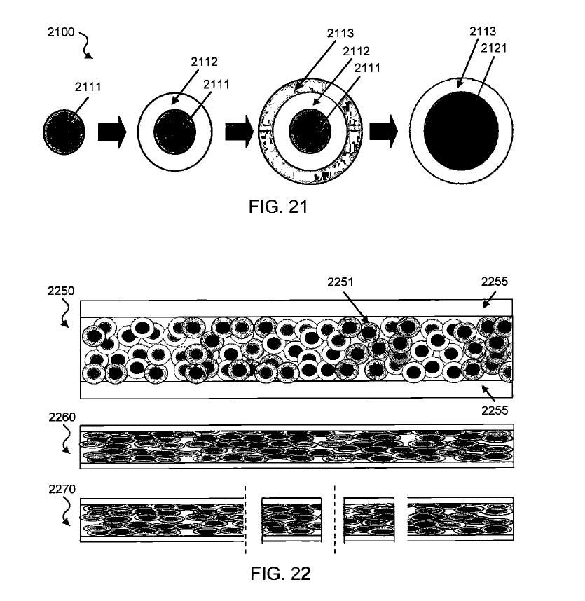

The disclosed technology can include alternative methods of fabricating the hard magnet core and soft magnet shell structure without severe magnetic agglomeration of single domain magnets. For example, a technique can include utilizing triple layered nanocomposite structures, as illustrated in FIG. 21 and FIG. 22.

FIG. 21 shows an exemplary diagram 2100 of a triple layer core-shell-shell coating with the two inner non-magnetic metals reacting to form hard magnet nanoparticles, while the outer layer remains as soft magnet layer. The diagram 2100 shows a particle 2111 of a nonmagnetic, non-agglomerating component nanoparticle, e.g., which can be formed of materials including, but not limited to, Mn, Bi, Nd—B, Al, α-Fe₂O₃, nonmagnetic nitride or carbide. For example, the particle 2111 can be formed by spark erosion, chemical synthesis, atomization, or grinding, among other techniques. The diagram 2100 shows the particle 2111 with a shell coating 2112, e.g., in which shell coating 2112 can be formed of another component metal layer (e.g., Bi, Mn, Fe, Nd, Al, Co). For example, the shell coating 2112 can be formed over the particle 2111 by electroless coating, electroplating, chemical functionalization, among other techniques. The diagram 2100 shows the particle 2111 having the shell coating 2112 with another shell layer 2113 deposited over the shell coating 2112. For example, the shell layer 2113 can be formed of a soft magnet metal material (e.g., Fe_{0.65}Co_{0.35}, CoP, Co, Fe, amorphous alloy, etc.). Subsequently, the resultant structure can undergo annealing for alloying of the exemplary nonmagnetic core 2111 with the inner exemplary shell 2112 to form hard magnet core 2121. The exemplary hard magnet core 2121 can be formed of a Mn core and Bi shell, or in some examples, of a Bi core and Mn shell, or in other examples, of an Nd—B core and Fe shell. An exemplary triple structure particle can include the hard magnet core 2121 coated by the soft magnet metal material shell 2113.

FIG. 21 shows the exemplary triple structure core/shell particle having two inner, non-magnetic metals (e.g., Bi and Mn) that provide an opportunity to provide heating to below ˜446° C. (e.g., and in some examples to below 355° C., and in other examples to below 262° C.), which can allow diffusional reactions of two metal mixing to form the strongly hard magnetic intermetallic core (e.g., MnBi). The exemplary outer layer can be selected to have a higher melting temperature (e.g., such as FeCo) than the inner hard magnetic intermetallic core (e.g., Bi or Bi—Mn alloy, so that FeCo remains as essentially intact soft magnet layer).

These exemplary triple structure core/shell particle can be subjected to uniaxial compressive deformation in a metal jacket to cause compaction or elongation (e.g., warm deformed), as shown in FIG. 22. The metallurgical reaction of two core metals may occur during plastic deformation or during subsequent heating. The uniaxial deformation may optionally be conducted at warm temperature, e.g., at or below 446° C., or in some examples, below 355° C., or even below 262° C.

FIG. 22 shows an exemplary diagram deformation compaction or elongation of jacketed preform material containing triple layered metal nanocomposite particles. An exchange-coupled spring magnet 2250 includes a composite perform material including triple core-shell-shell nanostructures 2251, e.g., such as the particles shown in the diagram 2100 of FIG. 21, embedded in a metal jacket material 2255. For example, the metal jacket material 2255 can be configured as a metal and/or alloy tube jacket including Cu, Ni, Fe, or stainless steel, among other metal materials. The exemplary triple-layer-coated nanoparticles can undergo reactions of two non-magnetic inner metals (e.g., Mn and Bi to mix and form hard magnet core MnBi), which can be coated in an outermost layer (e.g., FeCo layer staying as a soft magnet shell). The exemplary exchange-coupled spring magnet 2250 can be processed using compaction deformation techniques to form an elongated and aligned exchange-coupled spring magnet 2260, including elongated and aligned core-shell-shell nanoparticles (e.g., core/shell nanoparticles of anisotropically aligned MnBi or MnAl core/Fe_{0.65}CO_{0.35} shell), e.g., which can be optionally annealed (e.g., in a range of 200-700° C.) for consolidation and interface optimization. The exemplary elongated and aligned exchange-coupled spring magnet 2260 can be segmented into sliced elongated and aligned exchange-coupled spring magnet 2270. For example, the exemplary elongated and aligned exchange-coupled spring magnet 2260 can be sliced to a desired size and magnetized for use as high strength magnets. For example, an exemplary consolidation annealing treatment at 200-700° C. may also be applied after the slicing.

In another aspect, the disclosed technology can include methods, systems, and devices for NdFeB magnets with grain boundary decorations with domain wall pinning nanophases.

For example, in NdFeB (and also Sm—Co) magnet materials, domain wall pinning is an important issue toward improving the magnet properties. Thin film NdFeB magnets can be produced with improved magnetic properties using microstructural control or inclusion of domain wall pinning phases, but such significant improvements in structures and magnetic properties of NdFeB magnets have not been obtained in bulk NdFeB magnets.

Using the disclosed spark erosion techniques, various nanophase domain wall pinning centers can be introduced within bulk Nd—B—Fe alloys for improved magnet structures and magnetic properties. For example, rare earth metals and rare earth-containing alloys can be very easily oxidized, and thus NdFeB magnets can be more susceptible to deteriorated magnetic properties for nanoparticle-based NdFeB magnets. For example, in exchange spring magnets, the interface between the hard magnet phase surrounding soft magnet phase needs to be very clean without the presence of oxide layer, in order to make the exchange spring mechanism operable.

The disclosed technology can be implemented to produce NdFeB nanoparticle-based NdFeB magnets without oxidation hazards. For example, the disclosed spark erosion techniques can be used to obtain NdFeB magnet nanoparticles of less than 200 nm, and in some examples, less than 100 nm. For example, described are processes to fabricate the NdFeB magnet nanoparticles by spark erosion in cryogenic and inert dielectric liquid environments (e.g., such as liquid nitrogen or liquid argon), in which the fabricated NdFeB magnet nanoparticles can exhibit substantially no surface oxidation.

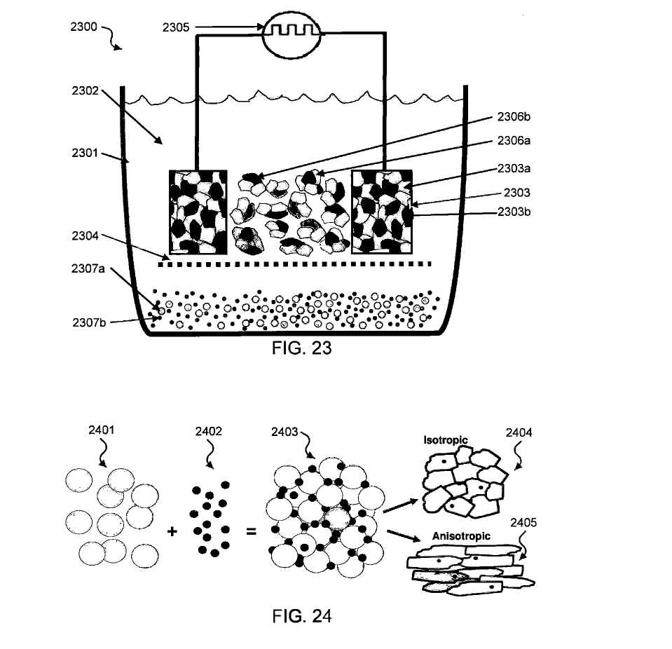

For example, spark eroded Dy (or Dy-rich alloy) nanoparticles can be utilized to further improve the NdFeB magnet microstructure (as exemplified in FIGS. 23-26) and associated magnet performance. Also for example, spark eroded Dy-free grain boundary barrier material nanoparticles (domain wall movement blocking) formed of materials including, but not limited to, Cu, Ag, Zn, Si, Sn, Sb, Bi, Mg, Al, other transition metals, rare earth and their alloys, can be utilized to further improve the NdFeB magnet microstructure. The elimination of Dy in the NdFeB based permanent magnets may be desirable in view of high cost and lack of sufficient supply of such a metal.

According to the disclosed technology, for the NdFeB-based permanent magnets, e.g., such as Nd₂Fe₁₄B (and also, for example, Sm—Co based permanent magnets such as SmCo₅ or Sm₂Co₁₇), various types of improved structures and magnet properties can be produced by using the disclosed spark eroded nanoparticles as described below. For example, one structure can include an exchange spring magnet based system in which the NdFeB or Sm—Co magnet phase is surrounded or in partial contact with soft magnetic phase having a higher magnetic saturation than the hard magnet core material (e.g., Fe, Co, or Fe—Co alloys such as Fe_{0.65}Co_{0.35} Fe—Si, Fe—Ni, amorphous magnets or other soft magnet alloys) so that the magnetic saturation and the energy product of the composite structure is significantly improved over the single phase base magnet material. For example, another structure can based on magnetic domain wall pinning enhancements utilizing the added non-magnetic or low-magnetic-moment nanoparticles into the NdFeB based on the disclosed spark erosion processing technology. For example, one structure can include “nanograined” NdFeB base type improved magnets (e.g., with a grain size of less than 500 nm, and in some examples, less than 200 nm average grain size, and in other examples, even less than 60 nm grain size), e.g., as a result of grain growth inhibitor foreign nanoparticles during subsequent consolidation due to the presence of either soft magnet coating and/or islands, or due to the presence of domain wall pinning nanoparticles (e.g., such as Cu, Ag, Zn, Si, Sn, Sb, Bi, Mg, Al, other transition metals, rare earth and their alloys).

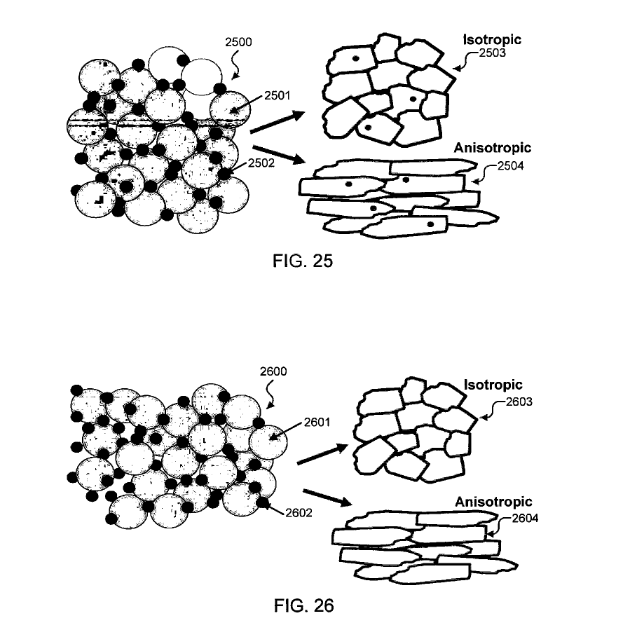

These exemplary structures described above can be obtained, according to the disclosed technology, by mechanical mixing of the NdFeB or Sm—Co type magnet nanoparticles produced by spark erosion with the soft magnet nanoparticles or domain wall pinning foreign material nanoparticles, e.g., by using attrition milling toward the structures, as illustrated in FIG. 24. For example, as single domain magnet nanoparticles can be easily agglomerated, a further improved processing technique is disclosed as illustrated in FIG. 23, FIG. 25 and FIG. 26.

FIG. 23 shows a schematic illustration of a spark erosion apparatus 2300 that uses composite electrodes 2303 containing a mix of NdFeB type rare earth containing hard magnet phase 2303a (e.g., NdFeB type rare earth containing hard magnet phase) and soft magnet phases 2303b, e.g., which can be made by compositing methods (e.g., such as low temperature, rapid sintering or spark welding of component nanoparticles) with minimal diffusion involved and by avoiding alloying of hard magnet elements with soft magnet elements. For example, the exemplary composite electrodes can contain a mix of NdFeB type rare earth containing hard magnet phase and non-magnetic, grain boundary barrier phase to serve as domain wall pinning material. Similarly as in FIG. 19, the spark erosion targets (electrodes and charge pieces) of FIG. 23 are configured into a composite structure that can be utilized to produce more uniformly mixed NdFeB magnet nanoparticles and soft magnet or domain-wall pinning nanoparticles as these particles get to mixed during spark erosion, as compared to the approaches of trying to mix two types of nanoparticles after their separate synthesis. Also, the exemplary spark erosion apparatus 2300 can be implemented in a manner similar to that previously described and shown in FIG. 2.

As shown in FIG. 23, the spark erosion apparatus 2300 can include a container 2301 that contains a dielectric fluid 2302 (e.g., such as liquid N₂, liquid Ar, or water) and spark erosion electrodes 2303 in connection to a pulsed power source 2305, e.g., to implement a spark erosion process in an exemplary manner as previously described. For example, electric fields can be generated in the gaps existing among the electrodes 2303 and charge pieces 2306 dispersed in the dielectric media 2302. For example, the bulk charge pieces 2306 can include phases of hard magnetic and soft magnetic materials, e.g., each exemplary charge piece 1906 can also be formed of a hard magnet phase 2306a and a soft magnet phase 2306b. For example, as described previously, microplasmas can be generated in these exemplary gaps, e.g., when the electric field in a gap is greater than the breakdown field of the dielectric. For example, when the spark collapses, tiny structures (e.g., molten droplets and/or vaporized material which can be of a nanoscale size) can be ejected into the dielectric, e.g., in which they are rapidly quenched/condensed. In some configurations, the exemplary spark erosion apparatus 2300 can include vibrating mechanisms, e.g., by using a shaker-pot configuration, or in some examples, a rotating-electrodes configuration. Implementations of the exemplary spark erosion apparatus 2300 can be performed to produce spark eroded mixture structures 2307a and 2307b that can be collected on the other side of a screen 2304 within the container 2301. For example, the spark eroded mixture structures 2307a can include hard magnet phase particles (e.g., Nd—Fe—B or Sm—Co type) that are mechanically mixed (and in some examples, lightly sintered or spark welded with) soft magnet metal or alloy particles 2307b (e.g., such as FeCo, Fe, Ni, Co, amorphous soft magnet) or grain boundary barrier material phase particles 2307b (e.g., such as Cu, Ag, Zn, Si, Sn, Sb, Bi, Mg, Al, other transition metals, rare earth and their alloys). For example, the mixed spark eroded particles 2307a and 2307b can provide more contact between the exemplary NdFeB or SmCo base hard magnet nanoparticles with the exemplary soft magnet or grain boundary barrier material nanoparticles. The exemplary spark eroded mixture structures 2307 can pass through a perforated mounting screen 2304 located at an end (e.g., the bottom) of the exemplary spark erosion apparatus 2300, in which the exemplary spark eroded mixture structures 2307 can be subsequently collected and processed.

Consolidation of the exemplary mixed nanoparticles of hard magnet particles 2307a and soft magnet (or domain-wall-pinning material) particles 2307b can be performed into usable solid magnet geometry can be performed by standard sintering, or alternatively with compressive and uniaxial deformation within a jacket such as by cold rolling, warm rolling, extrusion, swaging, rod drawing, followed by annealing heat treatment.

Referring to the FIG. 23, the exemplary composite spark erosion electrodes 2303 (targets) that contain NdFeB type hard magnet phases 2303a and soft magnet phases 2303b (or domain-wall pinning nonmagnetic phases 2303b) can be configured to a desired volume ratio of each phase of the composite two phase target of 40-80% hard magnet phase and 20-60% soft magnet phase (or domain-wall pinning nonmagnetic phase). In some examples, desired volume ratio of each phase of the composite two phase target can be 50-70% hard magnet phase and 30-50% soft magnet phase (or domain-wall-pinning nonmagnetic phases). For example, the desired sizes of the hard magnet and soft magnet regions can be selected so as to minimize undesirable alloying of the hard magnet and soft magnet elements during spark erosion. Therefore an exemplary size range of the hard magnet and soft magnet phases (or domain-wall pinning nonmagnetic phases) in the composite target (the electrodes and the charge pieces) can be configured to a size of at least 100 μm, or in some examples, at least 300 μm.

FIG. 24 shows a schematic demonstrating the mixing of two separately spark eroded hard magnet and soft magnet nanoparticles (or grain boundary barrier material (e.g., domain wall pinning phase) nanoparticles) and consolidation by sintering and/or uniaxial deformation for stronger magnet performance. In one example, spark eroded Nd—Fe—B magnet nanoparticles 2401 can be mixed with other nanoparticles 2402, for example, which can include spark eroded Dy (or Dy-rich alloy) nanoparticles or grain boundary barrier material nanoparticles (e.g., domain wall movement blocking materials and including Cu, Ag, Zn, Si, Sn, Sb, Bi, Mg, Al, other transition metals, rare earth and their alloys). The mixed nanoparticles can form a hard magnet and soft magnet two phase structure 2403. The exemplary magnet and soft magnet two phase structure 2403 can be compacted for sintering (e.g., in a reducing atmosphere), which can form sintered and diffusion mixed Nd—Dy—Fe—B alloy nanoparticles 2404 (isotropic nanoparticles) and/or 2405 (anisotropic nanoparticles), e.g., with grain boundary and interior decoration.

FIG. 25 shows a schematic demonstrating spark eroded nanoparticles from composite electrode/charge materials of exemplary NdFeB or Sm—Co phase hard magnet material 2501 and soft magnet material 2502 (e.g., Fe—Co, Fe, Co, Fe—Ni, or Co—P phase) to form an exemplary hard magnet/soft magnet two phase mixed nanoparticle phase structure 2500. For example, the exemplary mixed nanoparticle phase structure 2500 can be compacted and sintered to form NdFeB alloy particles 2503 with grain boundary exchange-biased, higher magnetization soft magnet layer. Additionally, for example, subsequent to compaction and sintering, the exemplary mixed nanoparticle phase structure 2500 can be configured as anisotropic aligned particles 2504, e.g., by magnetic field alignment and/or uniaxial deformation of rolling, swaging, extrusion, rod rolling, etc.

FIG. 26 shows a schematic demonstrating spark eroded nanoparticles from composite electrode/charge materials of exemplary NdFeB or Sm—Co phase hard magnet material 2601 and grain boundary barrier phase (domain wall movement blocking) material nanoparticles 2602 (e.g., Cu, Ag, Zn, Si, Sn, Sb, Bi, Mg, Al, other transition metals, rare earth and their alloys). For example, subsequent consolidation can be implemented with magnetic field particle alignment of easy axis and low temperature annealing for grain boundary diffusion of the domain wall pinning phase for pressing and sintering, e.g., to form Nd—Fe—B alloy particles 2603 with grain boundary domain-wall pinning layer. Additionally, for example, subsequent to compaction and sintering, the exemplary mixed nanoparticle phase structure 2600 can be configured as anisotropic aligned particles 2604, e.g., with anisotropic alignment by magnetic field align, followed by uniaxial deformation including, for example, rolling, swaging, extrusion, or rod rolling, among other techniques.

The described exchange interaction spring magnets or domain-wall-pinning magnets of NdFeB based systems illustrated in FIGS. 23-26 can exhibit significantly improved permanent magnet properties, e.g., particularly by employing the disclosed spark erosion techniques to produce the nanoparticles. For the NdFeB or Sm—Co base alloy systems, for example, the permanent magnets of the disclosed technology can be consolidated into a solid magnet geometry. For example, these consolidated permanent magnets can exhibit H_{c} of at least 5 KOe at room temperature (and in some examples, at least 10 KOe). The room temperature energy product BHₘₐₓ of the exemplary Dysprosium-free NdFeB alloy, or various Sm—Co based alloy exchange spring magnets permanent magnets can be configured to at least 10 MGOe (and in some examples, at least 20 MGOe, pr even at least 40 MGOe).

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

1. A method of fabricating a magnet, comprising:
distributing particles of a first magnetic material such that the particles are substantially separated, the particles including a surface substantially free of oxygen;
forming a coating of a second magnetic material over each of the particles, wherein the coating forms an interface at the surface that facilitates magnetic exchange coupling between the first and second magnetic materials; and
consolidating the coated particles to produce a magnet that is magnetically stronger than each of the first and second magnetic materials.

2. The method of claim 1, wherein the first magnetic material includes one of a hard magnet material or a soft magnet material and the second magnetic material includes the other of the hard magnet material or the soft magnet material.

3. (canceled)

4. (canceled)

5. The method of claim 1, further comprising producing the particles using a spark erosion process including:
dispersing bulk pieces of the first magnetic material into a dielectric fluid within a container;
generating an electric field in the dielectric fluid using an electric pulse, wherein the electric field creates a plasma in a volume existing between the bulk pieces that locally heats the bulk pieces to form structures within the volume, the dielectric fluid quenching the structures to form magnetic particles; and
filtering the magnetic particles through a screen including holes of a size to select magnetic particles to pass through the screen to a region in the container,
wherein the dielectric fluid inhibits oxidation of the surface of the magnetic particles.

6. (canceled)

7. (canceled)

8. (canceled)

9. (canceled)

10. (canceled)

11. The method of claim 5, further comprising annealing the filtered magnetic particles.

12. (canceled)

13. (canceled)

14. (canceled)

15. The method of claim 1, wherein the distributing the particles includes at least one of ultrasonic agitation, gas pressure blow agitation, or mechanical contact shear force agitation including brushing.

16. The method of claim 1, wherein the forming the coating includes implementing at least one of electrolytic or electroless deposition, sputter deposition, chemical vapor deposition, physical vapor deposition, or chemical decoration.

17. (canceled)

18. (canceled)

19. (canceled)

20. The method of claim 1, wherein the consolidating includes encasing the magnet in a metallic casing.

21. (canceled)

22. (canceled)

23. (canceled)

24. (canceled)

25. (canceled)

26. The method of claim 1, further comprising plastically deforming the magnet in at least one axial deformation direction, wherein the coated nanoparticles are elongated and aligned along the axial deformation direction in the magnet.

27. (canceled)

28. (canceled)

29. The method of claim 1, wherein the consolidating includes embedding the coated particles in a nonmagnetic material matrix.

30. (canceled)

31. A method of fabricating particles, comprising:
dispersing bulk pieces in a dielectric fluid containing spacer particles within a container that excludes oxygen, wherein the bulk pieces are of a hard magnet material;
generating an electric field in the dielectric fluid using an electric pulse, wherein the electric field creates a plasma in a volume existing between the bulk pieces that locally heats the bulk pieces to form structures within the volume, the dielectric fluid quenching the structures to form magnetic particles; and,
filtering the magnetic particles through a screen including holes of a size to select magnetic particles to pass through the screen to a region in the container, wherein the spacer particles mix with the selected magnetic particles in the region such that the magnetic particles are substantially separated,
wherein the magnetic particles include a surface substantially free of oxygen.

32. The method of claim 31, further comprising:
collecting the magnetic particles in an environment substantially free of oxygen;
forming a coating of a soft magnet material over each of the magnetic particles, wherein the coating forms an interface along an outer surface of the magnetic particles that facilitates magnetic exchange coupling between the soft magnet material and the hard magnet material; and
consolidating the coated magnetic particles to produce a magnet that is magnetically stronger than each of the hard magnet and soft magnet materials.

33. (canceled)

34. (canceled)

35. (canceled)

36. (canceled)

37. The method of claim 31, further comprising plastically deforming the magnet in at least one axial deformation direction, wherein the single-phase hard magnetic particles and the single-phase soft magnetic particles are elongated and aligned along the axial deformation direction.

38. (canceled)

39. A method of fabricating particles, comprising:
dispersing bulk pieces in a dielectric fluid within a container that excludes oxygen, wherein the bulk pieces are of a composite material including regions of a hard magnet material and regions of a soft magnet material;
generating an electric field in the dielectric fluid using an electric pulse, wherein the electric field creates a plasma in a volume existing between the bulk pieces that locally heats the composite material to form hard magnet structures and soft magnet structures within the volume, the dielectric fluid quenching the hard magnet structures and the soft magnet structures to form hard magnetic particles and soft magnetic particles; and
filtering the hard magnetic particles and the soft magnetic particles through a screen including holes of a size to select hard magnetic particles and soft magnetic particles to pass through the screen to a location in the container,
wherein the hard magnetic particles and the soft magnetic particles each include a surface substantially free of oxygen.

40. The method of claim 39, further comprising:
consolidating the hard magnetic particles and the soft magnetic particles to produce a magnet that is magnetically stronger than each of the hard magnet and soft magnet materials.

41. The method of claim 40, wherein the consolidating includes one or both of:
plastically deforming the magnet in at least one axial deformation direction, wherein the hard magnetic particles and the soft magnetic particles are elongated and aligned along the axial deformation direction, and
forming a coating of a soft magnet material over each of the hard magnetic particles.

42. (canceled)

43. The method of claim 41, wherein the consolidating includes embedding the coated particles in a nonmagnetic material matrix.

44. The method of claim 40, further comprising mixing nonmagnetic nanoparticles with the hard magnetic particles and the soft magnetic particles prior to the consolidating, wherein the mixed nonmagnetic nanoparticles are configured along grain boundaries within the magnet to provide domain wall pinning defects.

45. (canceled)

46. (canceled)

47. (canceled)

48. A magnet, comprising:
nanoparticles comprised of a first magnetic material including a first magnetic energy product, the nanoparticles including a surface substantially free of oxygen;
a layer at least partially covering each of the nanoparticles and forming an interface at the surface, the layer comprised of a second magnetic material including a second magnetic energy product, wherein the interface facilitates magnetic exchange coupling between the first and second magnetic materials; and
a casing formed of a metallic material or a nonmagnetic matrix material to at least partially encase the layer-covered nanoparticles.

49. The magnet of claim 48, wherein the first magnetic material includes one of a hard magnet material or a soft magnet material and the second magnetic material includes the other of the hard magnet material or the soft magnet material.

50. The magnet of claim 49, wherein the hard magnet material includes at least one of MnBi, MnAl, MnAlC, alloys of MnBi, alloys of MnAl, alloys of MnAlC, barium hexaferrite, strontium hexaferrite, NdFeB, alloys of NdFeB, samarium cobalt magnetic materials, alloyed cobalt materials, L1₀ magnetic materials, hard magnetic nitride materials, hard magnetic carbide materials, or rare earth magnetic materials.

51. The magnet of claim 49, wherein the soft magnet material includes at least one of iron, iron-cobalt alloys, or iron-based alloys including silicon steel, nickel iron permalloys, iron-cobalt-vanadium alloys, metglas, or high saturation soft ferrite materials.

52. The magnet of claim 48, wherein the magnet includes a magnetic energy product greater than the first magnetic energy product and the second magnetic energy product.

53. The magnet of claim 48, wherein the layer-covered nanoparticles are elongated and aligned.

54. (canceled)

55. (canceled)

56. (canceled)

57. The magnet of claim 48, wherein the magnet is implemented in at least one of an electric motor or electric power generator.

58. (canceled)

59. (canceled)

60. (canceled)

61. (canceled)

62. (canceled)

63. The magnet of claim 48, wherein the nonmagnetic matrix material includes copper, aluminum, epoxy, polymer resin, or ceramic materials including alumina.

64. (canceled)

65. (canceled)

66. (canceled)

67. The magnet of claim 48, further comprising doping elements in the layer-covered nanop articles.

68. The magnet of claim 67, wherein the doping atoms include at least one of Fe, Co, Ni atoms such that the doping elements within the magnet include at least a weight percent of 2 weight percent.

69. A magnetic device, comprising:
a soft magnet material exhibiting high saturation magnetization and forming a soft magnetic matrix; and
a hard magnet material configured in one or more nanometer regions embedded in the soft magnetic matrix to form an exchange-coupled magnet structure,
wherein the exchange-coupled magnet structure exhibits a magnetic energy product greater than that of the hard magnet material and the soft magnet material.

70. The magnetic device of claim 69, wherein the hard magnet material includes at least one of MnBi, MnAl, MnAlC, alloys of MnBi, alloys of MnAl, alloys of MnAlC, barium hexaferrite, strontium hexaferrite, NdFeB, alloys of NdFeB, samarium cobalt magnetic materials, alloyed cobalt materials, L1₀ magnetic materials, hard magnetic nitride materials, hard magnetic carbide materials, or rare earth magnetic materials.

71. The magnetic device of claim 69, wherein the soft magnet material includes at least one of iron, iron-cobalt alloys, or iron-based alloys including silicon steel, nickel iron permalloys, iron-cobalt-vanadium alloys, metglas, or high saturation soft ferrite materials.

72. The magnetic device of claim 69, wherein the device is implemented in at least one of an electric motor or electric power generator.
